(19) United States
(12) Patent Application Publication
(10) Pub. No.: US 2023/0383097 A1
(43) Pub. Date: Nov. 30, 2023

(54) SURFACE-TREATED ULTRAFINE CALCIUM CARBONATE FOR IMPROVING THE MECHANICAL PROPERTIES OF POLYETHYLENE/POLYPROPYLENE COMPOSITIONS

(71) Applicant: OMYA INTERNATIONAL AG, Oftringen (CH)

(72) Inventors: Samuel RENTSCH, Spiegel bei Bern (CH); Matthias WELKER, Hesingue (FR); Joris BARANGER, Kembs (FR)

(73) Assignee: OMYA INTERNATIONAL AG, Oftringen (CH)

(21) Appl. No.: 18/245,907

(22) PCT Filed: Oct. 4, 2021
(86) PCT No.: PCT/EP2021/077309

§ 371 Date: Mar. 20, 2023

(30) Foreign Application Priority Data
Oct. 5, 2020 (EP) 20200155.8

(51) Int. Cl. C08K 9/04; C08L 23/06; C08J 3/22

(52) U.S. Cl. CPC C08K 9/04; C08L 23/06; C08J 3/223; C08L 2205/025; C08L 2207/066; C08K 2201/005; C08K 2201/006; C08J 2323/06; C08J 2323/12; C08L 2207/062; C08L 2207/20

(57) ABSTRACT

The present invention relates to a filled polymer composition comprising polyethylene, polypropylene and an ultrafine calcium carbonate-containing filler material surface-treated with a surface-treatment agent, which has a total amount of carbon atoms from C4 to C34 and comprises at least one carboxyl group and/or a derivative thereof. The present invention further relates to a process for producing said filled polymer composition, the use of the surface-treated calcium carbonate-containing filler material for improving the mechanical properties of a polymer composition comprising polyethylene and polypropylene, as well as an article comprising the inventive filled polymer composition.

The present invention relates to a filled polymer composition comprising at least one polyethylene polymer and at least one polypropylene polymer, a process for the production thereof, the use of a surface-treated calcium carbonate-containing filler material in a polymer composition comprising at least one polyethylene polymer and at least one polypropylene polymer, as well as an article comprising the filled polymer composition.

### TECHNOLOGICAL BACKGROUND

Polyolefins, such as polyethylene and polypropylene, are ubiquitously used in a variety of applications, including packaging (in the form of plastic bags, films, containers, bottles, food packagings, microwavable containers, trays etc.), building and construction, automotive, electrical and electronic, agricultural, household, leisure and sports applications. In 2019, the European plastic converters demanded nearly 10 Mt of polypropylene, nearly 9 Mt of LDPE and LLDPE, and about 6 Mt of HDPE and MDPE. As many plastic products have a lifespan of less than one year, a huge amount of plastic waste is generated. In 2018, 29.1 Mt of post-consumer plastic waste were collected in the EU, whereof 32.5% were recycled, 42.6% were energetically recovered and 24.9% ended up on landfills. It has been estimated that worldwide, as of 2018, about 6300 Mt plastic waste had been generated. Thereof, only 9% were recycled and 12% were energetically recovered. 79% ended up on landfills. In view of steadily increasing awareness on environmental pollution and restrictions on plastic waste trade and landfill accumulation, there is a need to significantly increase the rates of plastic recycling. According to an EU Action Plan, circular economy is promoted to achieve “zero waste” and to recycle 100% of plastic waste by 2040.

Still, the recycling of plastics remains a challenging task, since plastic waste typically is a mixture of a variety of polymers. A common approach for their separation is sorting by gravimetry. However, different polyolefins have almost the same density (about 0.9 g/cm³) or may form part of multilayer films, such that they cannot be separated gravimetrically. Thus, the polymer mixture obtained thereby comprises mixtures of polyethylene polymers and polypropylene polymers, and optionally further small amounts of other polymers. As polyethylene and polypropylene are immiscible, the reprocessing of the so-obtained polymer mixture yields articles having poor mechanical properties. Therefore, the mechanical properties, such as the impact strength, of the so-obtained polymer composition have to be improved prior to re-use, for example, by improving the compatibility between polyethylene and polypropylene.

In the art, several approaches of compatibilizing polyethylene and polypropylene polymers have been suggested and include the use of compatibilizing or coupling agents, peroxide reagents and combinations thereof.

U.S. Pat. No. 9,969,868 B2 discloses methods and compositions related to recycling polymer waste, the composition comprising at least one polymer, a functional filler, and preferably a peroxide-containing additive. Applications US20170261131 A1, US20180186971 A1, US201190291301 A1 relate to polymer compositions comprising at least two polyethylene polymers, for example, recycled polymer compositions, a compatibilizer (or functional filler) and optionally a peroxide-containing additive. US20190153204 A1 relates to a resin composition comprising polypropylene, optionally polyethylene and a compatibilizer, wherein the polymers may be recycled polymers. In each of the aforementioned documents, the functional filler or compatibilizer comprises an inorganic particulate material and a coating comprising a first compound including a terminating propanoic group or ethylenic group with one or two adjacent carbonyl groups.

U.S. Pat. No. 4,873,116 discloses a method of preparing mixtures of incompatible hydrocarbon polymers using a compatibilizing system, comprising a mineral filler and reinforcement additives.

In view of the foregoing, there is still a need in the art for further and improved methods of improving the mechanical properties of and/or compatibilizing mixtures of polyethylene and polypropylene, in particular, mixtures of polyethylene and polypropylene derived from waste polymers. More precisely, there is a need for filler materials, which are capable of improving the mechanical properties of a polymer composition comprising mixtures of polyethylene and polypropylene, e.g., derived from waste polymers.

Accordingly, it is an objective of the present invention to provide a filler material for use in a polymer composition comprising at least one polyethylene polymer and at least one polypropylene polymer, wherein the mechanical properties of said polymer composition are improved. Preferably, the filler material can be easily handled and can be used for improving the mechanical properties of and/or for compatibilizing a wide range of polymer compositions comprising at least one polyethylene polymer and at least one polypropylene polymer, such as those polymer compositions, which are derived from waste polymers.

These and other objectives of the present invention can be solved by the inventive filled polymer composition, the process for the production of the inventive filled polymer composition, the use of a surface-treated calcium carbonate-containing filler material in a polymer composition, and the inventive article comprising the inventive filled polymer composition.

### SUMMARY OF THE INVENTION

According to one aspect of the present invention, a filled polymer composition is provided. The filled polymer composition comprises
a) at least one polyethylene polymer,
b) at least one polypropylene polymer, and
c) a surface-treated calcium carbonate-containing filler material in an amount from 5 wt.-% to 70 wt.-%, based on the total weight of the composition,
   wherein the surface-treated calcium carbonate-containing filler material comprises
an ultrafine calcium carbonate-containing filler material having
   i) a weight median particle size (d₅₀) value in the range from 0.03 μm to 1.0 μm and
   ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
   wherein the at least one surface-treatment agent
i) has a total amount of carbon atoms from C₄ to C₃₄, and
ii) comprises at least one carboxyl group and/or a derivative thereof.

The inventors surprisingly found that the surface-treated calcium carbonate-containing filler material acts as a compatibilizer of the at least one polyethylene polymer and the at least one polypropylene polymer. The mechanical properties, for example, the impact strength, can be improved, compared to the same composition not comprising any filler material or comprising the same filler material lacking the surface-treatment layer or comprising a calcium carbonate-containing filler material of the prior art. The inventive filler material is particularly efficient due to the interplay of the use of an ultrafine calcium carbonate-containing filler material, i.e., a calcium carbonate-containing filler material having a weight median particle size (d₅₀) value in the range from 0.03 μm to 1.0 μm and a top cut (d₉₈) value of 10 μm or less, and the specific surface-treatment layer deposited thereon. Without wishing to be bound by any theory, it is believed that the hydrophobic surface-treatment layer interacts with both the polyethylene phase and the polypropylene phase of the filled polymer composition and is entangled therein, such that the inventive filler can be positioned at the interface of both phases. Thereby, the interfacial adhesion of both phases is enhanced, similar to a Pickering emulsion. Thus, the inventive filler may act as a compatibilizer of the at least one polyethylene polymer and the at least one polypropylene polymer. At the same time, the particles of the inventive filler material can be uniformly dispersed throughout the polymer matrix and the formation of agglomerates and voids large enough to negatively influence the toughness of the filled polymer composition is avoided.

A second aspect of the present invention relates to a process for the production of a filled polymer composition. The process comprises the steps of
a) providing at least one polyethylene polymer and at least one polypropylene polymer and/or a polymer mixture comprising polyethylene and polypropylene,
b) providing a surface-treated calcium carbonate-containing filler material,
wherein the surface-treated calcium carbonate-containing filler material comprises an ultrafine calcium carbonate-containing filler material having
   i) a weight median particle size (d₅₀) value in the range from 0.03 μm to 1.0 μm and
   ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
   wherein the at least one surface-treatment agent
i) has a total amount of carbon atoms from C₄ to C₃₄, and
ii) comprises at least one carboxyl group and/or a derivative thereof,
c) mixing, in any order, the polyethylene polymer and the polypropylene polymer and/or the polymer mixture of step a), and the surface-treated calcium carbonate-containing filler material of step b) to obtain a mixture, and
d) compounding the mixture of step c) to obtain a filled polymer composition, wherein the filled polymer composition comprises the surface-treated calcium carbonate-containing filler material in an amount from 5 wt.-% to 70 wt.-%, based on the total weight of the filled polymer composition.

The present inventors found that the inventive filler material may be mixed with at least one polyethylene polymer and at least one polypropylene polymer or with a polymer mixture comprising polyethylene and polypropylene, which may be derived, e.g., from waste polymers, in a compounding step, for example, an extrusion step. The compounding allows for an intricate mixing of the respective materials, such that the interfacial area of the different phases, whereon the inventive filler material is positioned, can be maximized. Without wishing to be bound by any theory, it is believed that fibrils of polyethylene and polypropylene may be formed, the adhesion of which is mediated by the inventive filler material.

A third aspect of the present invention relates to the use of a surface-treated calcium carbonate-containing filler material in a polymer composition comprising at least one polyethylene polymer and at least one polypropylene polymer,

wherein the surface-treated calcium carbonate-containing filler material comprises an ultrafine calcium carbonate-containing filler material having
i) a weight median particle size (d₅₀) value in the range from 0.03 μm to 1.0 μm and
ii) a top cut (d₉₈) value of 10 μm or less,
   and a surface-treatment layer on at least a part of the surface of said ultrafine calcium carbonate-containing filler material, wherein the surface-treatment layer comprises at least one surface-treatment agent and/or salts reaction products thereof,
   wherein the at least one surface-treatment agent
i) has a total amount of carbon atoms from C₄ to C₃₄ and
ii) comprises at least one carboxyl group and/or a derivative thereof, for improving the mechanical properties of the polymer composition.

A fourth aspect of the present invention relates to an article comprising the inventive filled polymer composition.

Advantageous embodiments of the present invention can be found in the corresponding dependent claims.

In one embodiment of any one of the aspects of the present invention, the ultrafine calcium carbonate-containing filler material has
i) a weight median particle size (d₅₀) value in the range from 0.06 μm to 1.0 μm, preferably from 0.1 to 0.85 μm, more preferably from 0.12 μm to 0.7 μm, most preferably from 0.15 to 0.5 μm, and/or
ii) a top cut (d₉₈) value of 8 μm or less, preferably 6 μm or less, more preferably 4 μm or less, and most preferably 2.5 μm or less, and/or
iii) a specific surface area (BET) from 0.5 to 120 m²/g, preferably from 4 to 50 m²/g, more preferably from 6 to 35 m²/g, most preferably from 8 to 20 m²/g, as measured by the BET method, and/or
iv) a residual total moisture content of at most 0.5 wt.-%, preferably of at most 0.4 wt.-%, most preferably of at most 0.3 wt.-%, based on the total dry weight of the ultrafine calcium carbonate-containing filler material.

In another embodiment of any one of the aspects of the present invention, the surface-treatment layer is present on the ultrafine calcium carbonate-containing filler material in an amount of from 0.1 to 10 wt.-%, preferably from 0.3 to 7.5 wt.-%, more preferably from 0.8 to 5 wt.-%, still more preferably from 1.1 to 4 wt.-%, and most preferably from 2 to 4 wt.-%, based on the total amount of the surface-treated calcium carbonate-containing filler material.

In still another embodiment of any one of the aspects of the present invention, the surface-treatment layer does not comprise an unsaturated compound.

In yet another embodiment of any one of the aspects of the present invention, the surface-treated calcium carbonate-containing filler material has
i) a hydrophilicity in the range from 0.01 to 4, preferably from 0.02 to 3, more preferably 0.03 to 2, and most preferably from 0.04 to 1, indicated as the volumetric ratio of water:ethanol, measured at +23° C. (±2° C.) with the sedimentation method, and/or
ii) a moisture pick up susceptibility from 0.01 to 5 mg/g, preferably from 0.02 to 4 mg/g, more preferably from 0.03 to 2 mg/g and most preferably from 0.03 to 1.2 mg/g.

In one embodiment of any one of the aspects of the present invention, the at least one surface-treatment agent is a saturated surface-treatment agent, preferably wherein the saturated surface-treatment agent is selected from the group consisting of
I) at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof,
II) at least one mono-substituted succinic anhydride consisting of succinic anhydride mono-substituted with a group selected from a linear, branched, and cyclic aliphatic group having a total amount of carbon atoms from C₂ to C₃₀ in the substituent and/or a salt or an acid thereof,
III) salty reaction products of the materials according to I) and II), and
IV) mixtures of the materials according to I) to III).

In another embodiment of any one of the aspects of the present invention, the at least one surface-treatment agent is an unsaturated surface-treatment agent selected from the group consisting of
I) at least one mono-substituted succinic anhydride consisting of succinic anhydride mono-substituted with a group selected from a linear, branched and cyclic unsaturated group having a total amount of carbon atoms from C₂ to C₃₀ in the substituent and/or a salt or an acid thereof, and
II) salty reaction products of the materials according to I).

In yet another embodiment of any one of the aspects of the present invention,
a) the at least one polypropylene polymer is present in an amount from 0.5 to 99 wt.-%, preferably from 1 to 70 wt.-%, more preferably from 1 wt.-% to 50 wt.-%, most preferably from 1 to 30 wt.-%, based on the total weight of the polymer in the filled polymer composition, and/or
b) the surface-treated calcium carbonate-containing filler material is present in an amount from 5 wt.-% to 70 wt.-%, preferably from 5 wt.-% to 60 wt.-%, more preferably 7 wt.-% to 40 wt.-%, based on the total weight of the filled polymer composition.

In still another embodiment of any one of the aspects of the present invention, the filled polymer composition does not comprise a peroxide reagent and/or a reaction product thereof.

In one embodiment of any one of the aspects of the present invention, the filled polymer composition further comprises at least one additive selected from the group consisting of further fillers, preferably selected from the group consisting of talc, mica, kaolin, bentonite or mixtures thereof, UV-absorbers, light stabilizers, processing stabilizers, antioxidants, heat stabilizers, nucleating agents, metal deactivators, impact modifiers, plasticizers, lubricants, rheology modifiers, processing aids, pigments, dyes, optical brighteners, antimicrobials, antistatic agents, slip agents, anti-block agents, coupling agents, dispersants, compatibilizers, oxygen scavengers, acid scavengers, markers, antifogging agents, surface modifiers, flame retardants, blowing agents, smoke suppressors, or mixtures of the foregoing additives, and/or further comprises at least one further polymer preferably selected from the group comprising polystyrene, polyesters, preferably polyethylene terephthalate, polylactic acid, polyhydroxybutyrate and polyethylene-2,5-furandicarboxylate, polyvinyl chloride, polybutadiene, polyacrylonitrile, polymethylmethacrylate, polyamides, polyurethanes, and mixtures thereof.

In one embodiment of the process of the present invention,
i) mixing step c) and compounding step d) are performed simultaneously, preferably wherein the surface-treated calcium carbonate-containing filler material of step b) is admixed after mixing the polyethylene polymer and the polypropylene polymer and/or the polymer mixture of step a), more preferably wherein the mixture of the polyethylene polymer and the polypropylene polymer and/or the polymer mixture of step a) is at least partially in the molten state and/or
ii) compounding step d) is performed at a temperature in the range from 150 to 260° C., more preferably from 170 to 240° C., and most preferably from 180 to 230° C., and/or
iii) compounding step d) is an extrusion step.

In another embodiment of the process of the present invention, mixing step c) comprises the sub-steps of
c1) forming a masterbatch of the surface-treated calcium carbonate-containing filler material provided in step b) and at least one polyethylene polymer or at least one polypropylene polymer provided in step a), wherein the masterbatch comprises the surface-treated calcium carbonate-containing filler material in an amount from 40 to 80 wt.-%, preferably 45 to 75 wt.-%, more preferably 50 to 70 wt.-%, based on the total amount of the masterbatch, and
c2) mixing the masterbatch obtained in step c1) with the same or different at least one polyethylene polymer and/or at least one polypropylene polymer and/or polymer mixture comprising polyethylene and polypropylene of step a) to obtain a mixture comprising polyethylene and polypropylene, preferably wherein mixing step c2) and compounding step d) are performed simultaneously.

In yet another embodiment, the inventive process further comprises the step of
e) forming the filled polymer composition obtained in step d) into an article, preferably by injection moulding or film or sheet formation.

In one embodiment of any one of the aspects of the present invention, the impact strength of the polymer composition is increased, preferably by at least 5%, more preferably by at least 10%, determined by ISO 179-1eA:2010-11, compared to the same polymer composition not comprising the surface-treated calcium carbonate-containing filler material or compared to the same polymer composition comprising the same ultrafine calcium carbonate-containing filler material lacking a surface-treatment layer.

It should be understood that for the purposes of the present invention, the following terms have the following meanings.

The term “surface-treated calcium carbonate-containing filler material” in the meaning of the present invention refers to a material, which has been contacted with a surface-treatment agent such as to obtain a coating layer on at least a part of the surface of the calcium carbonate-containing filler material, wherein the calcium carbonate-containing filler material comprises at least 50 wt.-%, preferably at least 80 wt.-% calcium carbonate, based on the total dry weight of the surface-treated calcium carbonate-containing filler material.

The term “ground natural calcium carbonate” (GNCC) as used herein refers to a particulate material obtained from natural calcium carbonate-containing minerals, such as chalk, limestone, marble or dolomite, or from organic sources, such as eggshells or seashells, which has been processed in a wet and/or dry comminution step, such as crushing and/or grinding, and optionally has been subjected to further steps such as screening and/or fractionation, for example, by a cyclone or a classifier.

A “precipitated calcium carbonate” (PCC) in the present meaning is a synthesized material, obtained by precipitation following a reaction of carbon dioxide and calcium hydroxide (hydrated lime) in an aqueous environment. Alternatively, precipitated calcium carbonate can also be obtained by reacting calcium and carbonate salts, for example calcium chloride and sodium carbonate, in an aqueous environment. PCC may have a vateritic, calcitic or aragonitic crystalline form. PCCs are described, for example, in EP2447213 A1, EP2524898 A1, EP2371766 A1, EP2840065 A1, or WO2013/142473 A1.

The “particle size” of the calcium carbonate-containing materials herein is described by its weight distribution of particle sizes dₓ. Therein, the value dₓ represents the diameter relative to which x % by weight of the particles have diameters less than dₓ. This means that, for example, the d₂₀ value is the particle size at which 20 wt.-% of all particles are smaller than that particle size. The d₅₀ value is thus the weight median particle size, i.e. 50 wt.-% of all particles are smaller than that particle size and the d₉₈ value, referred to as top cut, is the particle size at which 98 wt.-% of all particles are smaller than that particle size. The weight median particle size d₅₀ and top cut d₉₈ are measured by the sedimentation method, which is an analysis of sedimentation behaviour in a gravimetric field. The measurement is made with a Sedigraph™ 5100 of Micromeritics Instrument Corporation, USA. The method and the instrument are known to the skilled person and are commonly used to determine particle size distributions.

The term “ultrafine calcium carbonate-containing filler material” refers to a particulate calcium carbonate-containing filler material having a weight median particle size (d₅₀) value of 0.03 μm to 1.0 μm and a top cut (d₉₈) value of 10 μm or less.

Throughout the present document, the term “specific surface area” (in m²/g), which is used to define calcium carbonate or other materials, refers to the specific surface area as determined by using the BET method (using nitrogen as adsorbing gas), as measured according to ISO 9277:2010.

For the purposes of the present application, the “volatile onset temperature” is defined as the temperature at which volatiles—including volatiles introduced as a result of common mineral filler preparation steps including grinding, with or without grinding aid agents, beneficiation, with or without flotation aid or other agents, and other pre-treatment agents not expressly listed above, detected according to the thermogravimetric analysis described hereafter—begin to evolve, as observed on a thermogravimetric (TGA) curve, plotting the mass of remaining sample (y-axis) as a function of temperature (x-axis), the preparation and interpretation of such a curve being defined hereafter. TGA analytical methods provide information regarding losses of mass and volatile onset temperatures with great accuracy, and is common knowledge; it is, for example, described in “Principles of Instrumental analysis”, fifth edition, Skoog, Holler, Nieman, 1998 (first edition 1992) in Chapter 31 pages 798 to 800, and in many other commonly known reference works. The thermogravimetric analysis (TGA) may be performed using a Mettler Toledo TGA/DSC3+ based on a sample of 250±50 mg in a 900 μL crucible and scanning temperatures from 25 to 280° C. or 25 to 400° C. at a rate of 20° C./minute under an air flow of 80 ml/min. The skilled man will be able to determine the “volatile onset temperature” by analysis of the TGA curve as follows: the first derivative of the TGA curve is obtained and the inflection points thereon between 150 and 280° C. or 25 to 400° C. are identified. Of the inflection points having a tangential slope value of greater than 45° relative to a horizontal line, the one having the lowest associated temperature above 200° C. is identified. The temperature value associated with this lowest temperature inflection point of the first derivative curve is the “volatile onset temperature”. The total weight of the surface treatment agent on the accessible surface area of the filler can be determined by thermogravimetric analysis by mass loss between 105° C. to 400° C.

For the purposes of the present application, the “total volatiles” associated with mineral fillers and evolved over a temperature range of 25 to 280° C. or 25 to 400° C. is characterised according to % mass loss of the mineral filler sample over a temperature range as read on a thermogravimetric (TGA) curve. The “total volatiles” evolved on the TGA curve can be determined using Star® SW 9.01 software. Using this software, the curve is first normalised relative to the original sample weight in order to obtain mass losses in % values relative to the original sample. Thereafter, the temperature range of 25 to 280° C. or 25 to 400° C. is selected and the step horizontal (in German: “Stufe horizontal”) option selected in order to obtain the % mass loss over the selected temperature range.

Unless indicated otherwise, the “residual total moisture content” of a material refers to the percentage of moisture (i.e. water) which may be desorbed from a sample upon heating to 220° C. The “residual total moisture content” is determined according to the Coulometric Karl Fischer measurement method, wherein the filler material is heated to 220° C., and the water content released as vapor and isolated using a stream of nitrogen gas (at 80 ml/min) is determined in a Coulometric Karl Fischer unit (e.g. Mettler-Toledo coulometric KF Titrator C30, combined with Mettler-Toledo oven DO 0337).

The term “moisture pick-up susceptibility” in the meaning of the present invention refers to the amount of moisture adsorbed on the surface of the powder material or surface-treated filler material product and can be determined in mg moisture/g of the dry powder material or surface-treated filler material product after exposure to an atmosphere of 10 and 85% of relative humidity, respectively, for 2.5 hours at a temperature of +23° C. (±2° C.).

The term “(total) dry weight of the calcium carbonate-containing filler material” is understood to describe a filler material having less than 0.4% by weight of water relative to the filler material weight. The % water (equal to residual total moisture content) is determined as described herein.

As used herein, the term “polymer” generally includes homopolymers and co-polymers such as, for example, block, graft, random and alternating copolymers, as well as blends and modifications thereof. The polymer can be an amorphous polymer, a crystalline polymer, or a semi-crystalline polymer, i.e. a polymer comprising crystalline and amorphous fractions. The degree of crystallinity is specified in percent and can be determined by differential scanning calorimetry (DSC). An amorphous polymer may be characterized by its glass transition temperature and a crystalline polymer may be characterized by its melting point. A semi-crystalline polymer may be characterized by its glass transition temperature and/or its melting point.

For the purposes of the present invention, a “polyethylene polymer” is understood to relate to a polymer, which is derived from at least 50 mol-%, preferably at least 75 mol-%, more preferably at least 90 mol-% polyethylene monomers, based on the total amount of monomers in the polymer. Likewise, a “polypropylene polymer” is understood to designate a polymer, which is derived from at least 50 mol-%, preferably at least 75 mol-%, more preferably at least 90 mol-% polypropylene monomers, based on the total amount of monomers in the polymer.

The expression “isotactic polymer” refers to a polymer, wherein more than 95%, preferably more than 97% of all substituents are located on the same side of the macromolecular backbone.

The term “melt flow rate” (MFR) as used herein refers to the mass of the polymer, given in g/10 min, which is discharged through a defined die under specified temperature and pressure conditions. For polyethylene polymers, the MFR is commonly measured under a load of 2.16 kg at 190° C., according to EN ISO 1133:2011. For polypropylene polymers, the MFR is commonly measured under a load of 2.16 kg at 230° C., according to EN ISO 1133:2011. The MFR is a measure of the viscosity of the polymer, which is mainly influenced by the molecular weight of the polymer, but also by the degree of branching or the polydispersity.

The expression “polydispersity index” (M_{w}/Mₙ) as used herein is a measure of the molecular mass distribution and refers to the ratio of the weight-average molar mass and the number-average molar mass of the polymers as determined by gel permeation chromatography (GPC), e.g., according to EN ISO 16014-1:2019.

The term “masterbatch” refers to a composition having a concentration of the surface-treated calcium carbonate-containing filler material that is higher than the concentration of the final filled polymer composition. That is to say, the masterbatch is further diluted, e.g., during step c) and/or step d) of the process of the present invention, such as to obtain the final filled polymer composition.

For the purposes of the present invention, the term “waste polymers” is understood to refer to polymers originating from plastic waste, i.e., waste comprising or consisting essentially of polymers that have been disposed of, e.g., after having exceeded their service life. In one embodiment, the plastic waste is post-consumer plastic waste. For the purposes of the present invention, the term “post-consumer plastic waste” refers to plastic waste generated by consumers. In another embodiment, the plastic waste is post-industrial plastic waste. For the purposes of the present invention, the term “post-industrial plastic waste” refers to plastic waste generated in the industry or during the manufacture of polymeric articles.

The term “waste polymers” is understood to include “primary plastics”, i.e., plastics that are in their original form when collected, and “secondary plastics”, i.e., plastics that have resulted from the partial degradation of primary plastics.

Plastic waste typically is a mixture of several types of polymeric materials, including, but not limited to polyolefins, such as polyethylene (PE) and polypropylene (PP), polyesters, such as polyethylene terephthalate (PET) and polylactic acid (PLA), polyvinyl chloride (PVC), polystyrene (PS), polyurethanes (PUR), polycarbonates (PC), polyamides (PA), polyimides (PI), and/or polyether ether ketone (PEEK). Furthermore, plastic waste may contain further additives, such as pigments, dyes, antioxidants, flame retardants or fillers, and contaminants. Common contaminants include residues of packaged goods, dirt and/or grease.

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined hereinabove.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

According to one embodiment of the present invention, a filled polymer composition is provided. The filled polymer composition comprises
a) at least one polyethylene polymer,
b) at least one polypropylene polymer, and
c) a surface-treated calcium carbonate-containing filler material in an amount from 5 wt.-% to 70 wt.-%, based on the total weight of the composition,
   wherein the surface-treated calcium carbonate-containing filler material comprises
an ultrafine calcium carbonate-containing filler material having
   i) a weight median particle size (d₅₀) value in the range from 0.03 μm to 1.0 μm and
   ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
   wherein the at least one surface-treatment agent
i) has a total amount of carbon atoms from C₄ to C₃₄, and
ii) comprises at least one carboxyl group and/or a derivative thereof.

When in the following reference is made to embodiments or technical details of the inventive filled polymer composition, it is to be understood that these embodiments or technical details also refer to the inventive process, the inventive use and the inventive article.

### The at Least One Polyethylene Polymer

The inventive filled polymer composition, the inventive process, the inventive use and the inventive article make use of at least one polyethylene polymer.

For example, the at least one polyethylene polymer is a homopolymer and/or copolymer of polyethylene. The at least one polyethylene polymer may be a homopolymer of polyethylene.

The expression homopolymer of polyethylene used in the present invention relates to polyethylene comprising a polyethylene that consists substantially, i.e. of more than 99.7 wt.-%, still more preferably of at least 99.8 wt.-%, based on the total weight of the polyethylene, of ethylene units. For example, only ethylene units in the homopolymer of polyethylene are detectable.

For example, the polyethylene polymer may be selected from the group comprising homopolymers and/or copolymers of polyethylene like high-density polyethylene (HDPE), medium-density polyethylene (MDPE), low-density polyethylene (LDPE), very low-density polyethylene (VLDPE), linear low-density polyethylene (LLDPE), and mixtures thereof.

In case the at least one polymeric resin of the polymer composition comprises a copolymer of polyethylene, it is appreciated that the polyethylene contains units derivable from ethylene as major components. Accordingly, the copolymer of polyethylene comprises at least 55 wt.-% units derivable from ethylene, more preferably at least 60 wt.-% of units derived from ethylene, based on the total weight of the polyethylene. For example, the copolymer of polyethylene comprises 60 to 99.5 wt.-%, more preferably 90 to 99 wt.-%, units derivable from ethylene, based on the total weight of the polyethylene. The comonomers present in such copolymer of polyethylene are C₃ to C₁₀ α-olefins, preferably 1-butene, 1-hexene and 1-octene, the latter being especially preferred.

Furthermore, it is appreciated that the at least one polyethylene polymer may be selected from polyethylene polymers having a broad spectrum of melt flow rate. In general, it is preferred that the at least one polyethylene polymer has a melt flow rate MFR (190° C., 2.16 kg) of from 0.1 to 3 000 g/10 min, more preferably of from 0.2 to 2 500 g/10 min. For example, the at least one polyethylene polymer has a melt flow rate MFR (190° C., 2.16 kg) of from 0.3 to 2 000 g/10 min, preferably from 0.3 to 1 600 g/10 min, more preferably from 1 to 100 g/10 min and most preferably from 1 to 50 g/10 min.

The at least one polyethylene polymer may have a rather low melt flow rate. Accordingly, it is preferred that the at least one polyethylene polymer has a melt flow rate MFR (190° C., 2.16 kg) of from 0.5 to 50 g/10 min, more preferably of from 0.7 to 45 g/10 min. For example, the at least one polyethylene polymer has a melt flow rate MFR (190° C., 2.16 kg) of from 0.9 to 40 g/10 min, preferably from 0.9 to 30 g/10 min.

In one embodiment of the present invention, the at least one polyethylene polymer is a virgin polymer, that is, the polyethylene polymer is produced directly from the petrochemical feed-stock.

In a preferred embodiment of the present invention, the at least one polyethylene polymer is derived from waste polymers. In view thereof, the at least one polyethylene polymer being “derived from” waste polymers is understood in that the polyethylene polymer is obtained by a purification process. The purification process may include at least one of, preferably at least two of the steps of pre-sorting, grinding, cleaning and sorting, in any order, preferably in the order set out herein.

In one embodiment, the process for obtaining the polyethylene polymer comprises a pre-sorting step. During pre-sorting, separate and discrete pieces of different polymeric materials may be identified, e.g., by Fourier-transform infrared spectroscopy (FTIR), near-infrared spectroscopy, optical color recognition, X-ray detection, laser sorting and/or electrostatic detection, and subsequently mechanically separated, e.g., by selective collection and/or automated or manual sorting.

In one embodiment, the process for obtaining the polyethylene polymer comprises a grinding step. During the grinding step, the size of the waste plastic is reduced in order to facilitate the subsequent separation, cleaning and re-processing steps. The grinding step may be performed inter alia by shredding, crushing or milling. Preferably, the average particle size of the ground waste plastic is in the range from 0.2 to 10 mm.

In one embodiment, the process for obtaining the polyethylene polymer comprises a cleaning step. During cleaning, the waste plastic, which is optionally ground, may be washed with a liquid preferably selected from the group consisting of water, optionally comprising at least one detergent and/or a soap, and/or organic solvents, such as alcohols, ketones and aliphatic hydrocarbons. Preferably, the organic solvent does not dissolve the polymers within the waste plastic.

In one embodiment, the process for obtaining the polyethylene polymer comprises a sorting step. The sorting step may be selected from gravimetrical sorting and/or sorting by dissolution/reprecipitation.

For the purposes of the present invention, the term “gravimetrical sorting”, also termed “sink-float density separation” or “density separation” refers to a method for separating different types of polymers based on their respective density. During gravimetrical sorting, the waste plastic, which is preferably ground and optionally cleaned, may be dispersed in a solvent having a defined density and sorted in a gravity separator, a sorting cyclone or a sorting centrifuge. Thereby, the plastic waste fractions are separated according to their density, i.e., the plastic waste fraction having a density below the density of the solvent floats to the top, and the plastic waste having a density above the density of the solvent sinks to the bottom. The so-obtained plastic waste fractions may be subject to another gravimetrical sorting step using a solvent having a different density. Suitable solvents include water, alcohols, and salt solutions.

Alternatively, in the “dissolution/reprecipitation” process, the waste plastic, which is preferably ground and optionally cleaned, may be dissolved in a solvent, such as xylene, toluene, dichloromethane, benzyl alcohol or a mixture thereof. Subsequently, a non-solvent, such as n-hexane or methanol, is added to selectively precipitate the different polymeric materials. The process may be repeated one or more times.

Preferably, the process for obtaining the polyethylene polymer comprises a drying step. Drying may take place using any suitable drying equipment and can, for example, include thermal drying and/or drying at reduced pressure using equipment such as an evaporator, a flash drier, an oven, a spray drier (such as a spray drier sold by Niro and/or Nara), and/or drying in a vacuum chamber.

In view of the foregoing, it is to be understood that, in case the at least one polyethylene polymer is derived from waste plastic, the at least one polyethylene polymer may comprise further polymers and/or additives and/or contaminants, depending on the composition of the waste plastic. Therefore, the present invention is not limited to certain types or compositions of polyethylene polymers. In particular, the polyethylene polymer may be selected from the group consisting of HDPE, MDPE, LDPE, VLDPE, LLDPE, and mixtures thereof, may comprise further polymers, such as PP, PET, PVC, PLA, PA and/or PS, and/or may comprise further additives.

The expression “at least one” polyethylene polymer means that one or more kinds of polyethylene polymer may be present in the inventive filled polymer composition. Accordingly, it is appreciated that the at least one polyethylene polymer may be a mixture of two or more kinds of polyethylene polymers, e.g., a mixture of LDPE and/or LLDPE with MDPE and/or HDPE.

### The at Least One Polypropylene Polymer

The inventive filled polymer composition, the inventive process, the inventive use and the inventive article make use of at least one polypropylene polymer. The polypropylene polymer may be a homopolymer and/or copolymer of polypropylene.

The expression homopolymer of polypropylene as used throughout the instant invention relates to a polypropylene that consists substantially, i.e. of more than 99 wt.-%, still more preferably of at least 99.5 wt.-%, like of at least 99.8 wt.-%, based on the total weight of the polypropylene, of propylene units. In a preferred embodiment only propylene units are detectable in the homopolymer of polypropylene. The homopolymer of polypropylene may be an isotactic polypropylene homopolymer.

In case the at least one polymeric resin of the polymer composition comprises a copolymer of polypropylene, the polypropylene preferably contains units derivable from propylene as major components. The copolymer of polypropylene preferably comprises, preferably consists of, units derived from propylene and C₂ and/or at least one C₄ to C₁₀ α-olefin. In one embodiment of the present invention, the copolymer of polypropylene comprises, preferably consists of, units derived from propylene and at least one α-olefin selected from the group consisting of ethylene, 1-butene, 1-pentene, 1-hexene and 1-octene. For example, the copolymer of polypropylene comprises, preferably consists of, units derived from propylene and ethylene. In one embodiment of the present invention, the units derivable from propylene constitutes the main part of the polypropylene, i.e. at least 60 wt.-%, preferably of at least 70 wt.-%, more preferably of at least 80 wt.-%, still more preferably of from 60 to 99 wt.-%, yet more preferably of from 70 to 99 wt.-% and most preferably of from 80 to 99 wt.-%, based on the total weight of the polypropylene. The amount of units derived from C₂ and/or at least one C₄ to C₁₀ α-olefin in the copolymer of polypropylene, is in the range of 1 to 40 wt.-%, more preferably in the range of 1 to 30 wt.-% and most preferably in the range of 1 to 20 wt.-%, based on the total weight of the copolymer of polypropylene.

If the copolymer of polypropylene comprises only units derivable from propylene and ethylene, the amount of ethylene is preferably in the range of 1 to 20 wt.-%, preferably in the range of 1 to 15 wt.-% and most preferably in the range of 1 to 10 wt.-%, based on the total weight of the copolymer of polypropylene. Accordingly, the amount of propylene is preferably in the range of 80 to 99 wt.-%, preferably in the range of 85 to 99 wt.-% and most preferably in the range of 90 to 99 wt.-%, based on the total weight of the copolymer of polypropylene.

Furthermore, it is appreciated that the at least one polypropylene polymer may be selected from polypropylene polymers having a broad spectrum of melt flow rate. In general, it is preferred that the at least one polypropylene polymer has a melt flow rate MFR (230° C., 2.16 kg) of from 0.1 to 3 000 g/10 min, more preferably of from 0.2 to 2 500 g/10 min. For example, the at least one polypropylene polymer has a melt flow rate MFR (230° C., 2.16 kg) of from 0.3 to 2 000 g/10 min, preferably from 0.3 to 1 600 g/10 min, more preferably from 1 to 100 g/10 min, most preferably from 1 to 50 g/10 min.

In one embodiment of the present invention, the at least one polypropylene polymer is a virgin polymer, that is, the polypropylene polymer is produced directly from the petrochemical feed-stock.

In a preferred embodiment of the present invention, the at least one polypropylene polymer is derived from waste polymers. The at least one polypropylene polymer being “derived from” waste polymers is understood in that the polypropylene polymer is obtained by a purification process. Suitable purification processes are described hereinabove within context of the at least one polyethylene polymer.

In view of the foregoing, it is to be understood that, in case the at least one polypropylene polymer is derived from waste plastic, the at least one polypropylene polymer may comprise further polymers and/or additives and/or contaminants, depending on the composition of the waste plastic. Therefore, the present invention is not limited to certain types or compositions of polypropylene polymers. In particular, the polypropylene polymer may be selected from the group consisting of expandable polypropylene (EPP), high-impact polypropylene (HIPP), and mixtures thereof, may comprise further polymers, such as PE, PET, PVC, PLA, PA and/or PS, and/or may comprise further additives.

The expression “at least one” polypropylene polymer means that one or more kinds of polypropylene polymer may be present in the inventive filled polymer composition. Accordingly, it is appreciated that the at least one polypropylene polymer may be a mixture of two or more kinds of polypropylene polymers.

### The Surface-Treated Calcium Carbonate-Containing Filler Material

The inventive filled polymer composition, the inventive process, the inventive use and the inventive article make use of a surface-treated calcium carbonate-containing filler material. The surface-treated calcium carbonate-containing filler material comprises
an ultrafine calcium carbonate-containing filler material having
   i) a weight median particle size (d₅₀) value in the range from 0.03 μm to 1.0 μm and
   ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
   wherein the at least one surface-treatment agent
i) has a total amount of carbon atoms from C₄ to C₃₄, and
ii) comprises at least one carboxyl group and/or a derivative thereof.

The surface-treated calcium carbonate-containing filler material is formed by contacting the ultrafine calcium carbonate-containing filler material and the at least one surface-treatment agent.

### The Ultrafine Calcium Carbonate-Containing Filler Material

The ultrafine calcium carbonate-containing filler material in the meaning of the present invention refers to a material preferably selected from the group consisting of ground natural calcium carbonate (GNCC), precipitated calcium carbonate (PCC) and mixtures thereof, having
i) a weight median particle size (d₅₀) value in the range from 0.03 μm to 1.0 μm and
ii) a top cut (d₉₈) value of 10 μm or less.

Preferably, the ultrafine calcium carbonate-containing filler material is a GNCC.

According to one embodiment of the present invention, the amount of calcium carbonate in the ultrafine calcium carbonate-containing filler material is at least 80 wt.-%, e.g. at least 95 wt.-%, preferably between 97 and 100 wt.-%, more preferably between 98.5 and most preferably 99.95 wt.-%, based on the total dry weight of the ultrafine calcium carbonate-containing filler material.

The ultrafine calcium carbonate-containing filler material is in the form of a particulate material, and has a particle size distribution as required for the filled polymer composition of the present invention. Thus, the ultrafine calcium carbonate-containing filler material has a weight median particle size d₅₀ from 0.03 μm to 1.0 μm, preferably from 0.06 μm to 1.0 μm, more preferably from 0.1 to 0.85 μm, even more preferably from 0.12 μm to 0.7 μm and most preferably from 0.15 to 0.5 μm.

The present inventors found that the particle size of the ultrafine surface-treated calcium carbonate-containing filler material is of particular importance for obtaining the desired improvement of the mechanical properties of the filled polymer composition. Therefore, the particle size of the ultrafine calcium carbonate-containing filler material is selected accordingly. The weight median particle size should not exceed 1.0 μm, since the larger particles may induce large voids acting as initiation sites for fracturing. However, the weight median particle size at the same time should not be below 0.03 μm, since the very fine particles tend to form larger aggregates, which cannot be easily deaggregated, e.g., during a surface-treatment step.

Additionally or alternatively, the ultrafine calcium carbonate-containing filler material has a top cut (d₉₈) of 10 μm or less, preferably 8 μm or less, more preferably 6 μm or less, even more preferably 4 μm or less, and most preferably 2.5 μm or less. It is understood that the top cut of the material is selected such that the particles can be evenly distributed in the filled polymer composition.

Additionally or alternatively, the ultrafine calcium carbonate-containing filler material may have a BET specific surface area of from 0.5 and 120 m²/g, preferably from 4 to 50 m²/g, more preferably from 6 to 35 m²/g, and most preferably from 8 to 20 m²/g, as measured by the BET method according to ISO 9277:2010.

Additionally or alternatively, the ultrafine calcium carbonate-containing filler material may have a residual total moisture content of at most 0.5 wt.-%, for example from 0.001 wt.-% to 0.5 wt.-%, preferably of at most 0.4 wt.-%, for example from 0.002 wt.-% to 0.4 wt.-%, most preferably of at most 0.3 wt.-%, for example from 0.0025 wt.-% to 0.3 wt.-%, based on the total dry weight of the ultrafine calcium carbonate-containing filler material.

According to one embodiment of the present invention, the ultrafine calcium carbonate-containing filler material has a weight median particle size d₅₀ from 0.03 μm to 1.0 μm and/or a top cut (d₉₈) of 10 μm or less and/or a specific surface area (BET) of from 0.5 to 120 m²/g, as measured by the BET method.

In one embodiment of the present invention, the ultrafine calcium carbonate-containing filler material is preferably a ground natural calcium carbonate having a median particle size diameter d₅₀ value from 0.03 μm to 1.0 μm, preferably from 0.06 μm to 1.0 μm, more preferably from 0.1 to 0.85 μm, even more preferably from 0.12 μm to 0.7 μm, and most preferably from 0.15 to 0.5 μm. In this case, the ultrafine calcium carbonate-containing filler material may exhibit a BET specific surface area of from 0.5 to 120 m²/g, preferably of from 4 to 50 m²/g, more preferably of from 6 to 35 m²/g and most preferably of from 8 to 20 m²/g, measured by the BET method.

For example, the ultrafine calcium carbonate-containing filler material may have a median particle size diameter d₅₀ value from 0.12 μm to 0.7 μm, preferably from 0.15 μm to 0.5 μm, a top cut (d₉₈) of 8 μm or less, more preferably of 4 μm or less, and optionally a BET specific surface area of from 4 to 50 m²/g, preferably of from 6 to 35 m²/g, measured by the BET method.

It is preferred that the ultrafine calcium carbonate-containing filler material is a dry ground material, a material being wet ground and dried or a mixture of the foregoing materials. In general, the grinding step can be carried out with any conventional grinding device, for example, under conditions such that refinement predominantly results from impacts with a secondary body, i.e., in one or more of a ball mill, a rod mill, a vibrating mill, a roll crusher, a centrifugal impact mill, a vertical bead mill an attrition mill, a pin mill, a hammer mill, a pulveriser, a shredder, a de-clumper, a knife cutter, or other such equipment known to the skilled man.

In case the ultrafine calcium carbonate-containing filler material is a wet ground calcium carbonate-containing filler material, the grinding step may be performed under conditions such that autogenous grinding takes place and/or by horizontal ball milling, and/or other such processes known to the skilled man. It is to be noted that the same grinding methods can be used for dry grinding the ultrafine calcium carbonate-containing filler material. The wet processed ground calcium carbonate-containing filler material thus obtained may be washed and dewatered by well-known processes, e.g. by flocculation, filtration or forced evaporation prior to drying. The subsequent step of drying may be carried out in a single step such as spray drying, or in at least two steps, e.g. by applying a first heating step to the ultrafine calcium carbonate-containing filler material in order to reduce the associated moisture content to a level which is not greater than about 0.5 wt.-%, based on the total dry weight of the ultrafine calcium carbonate-containing filler material. The residual total moisture content of the filler material can be measured by the Karl Fischer coulometric titration method, desorbing the moisture in an oven at 195° C. and passing it continuously into the KF coulometer (Mettler Toledo coulometric KF Titrator C30, combined with Mettler oven DO 0337) using dry N₂ at 100 ml/min, e.g. for 10 min. The residual total moisture content may be further reduced by applying a second heating step to the ultrafine calcium carbonate-containing filler material. In case said drying is carried out by more than one drying steps, the first step may be carried out by heating in a hot current of air, while the second and further drying steps are preferably carried out by an indirect heating in which the atmosphere in the corresponding vessel comprises a surface treatment agent. It is also common that the ultrafine calcium carbonate-containing filler material is subjected to a beneficiation step (such as a flotation, bleaching or magnetic separation step) to remove impurities.

In one embodiment of the present invention, the ultrafine calcium carbonate-containing filler material comprises a dry ground calcium carbonate-containing filler material. In another preferred embodiment, the ultrafine calcium carbonate-containing filler material is a material being wet ground, and subsequently dried.

According to the present invention, the ultrafine calcium carbonate-containing filler material may have a residual total moisture content of at most 0.5 wt.-%, for example from 0.001 to 0.5 wt.-%, based on the total dry weight of the ultrafine calcium carbonate-containing filler material. Depending on the ultrafine calcium carbonate-containing filler material, the ultrafine calcium carbonate-containing filler material may have a residual total moisture content of at most 0.4 wt.-%, for example from 0.002 to 0.4 wt.-%, preferably from 0.01 to 0.3 wt.-% and most preferably from 0.02 to 0.3 wt.-%, based on the total dry weight of the ultrafine calcium carbonate-containing filler material.

For example, in case a wet ground and spray dried marble is used as ultrafine calcium carbonate-containing filler material, the residual total moisture content of the ultrafine calcium carbonate-containing filler material is preferably from 0.01 to 0.5 wt.-%, more preferably from 0.02 to 0.4 wt.-%, and most preferably from 0.04 to 0.3 wt.-%, based on the total dry weight of the ultrafine calcium carbonate-containing filler material. If a PCC is used as ultrafine calcium carbonate-containing filler material, the residual total moisture content of the ultrafine calcium carbonate-containing filler material is preferably in the range from 0.01 to 0.4 wt.-%, more preferably from 0.05 to 0.3 wt.-%, and most preferably from 0.05 to 0.2 wt.-%, based on the total dry weight of the ultrafine calcium carbonate-containing filler material.

As a non-limiting example, the ultrafine calcium carbonate-containing filler material may be obtained by a process as described in WO2016110459 A1 or the references cited therein.

According to one embodiment of the present invention, the precipitated calcium carbonate is precipitated calcium carbonate, preferably comprising aragonitic, vateritic or calcitic mineralogical crystal forms or mixtures thereof.

In a preferred embodiment of the present invention, the ultrafine calcium carbonate-containing filler material comprises a precipitated calcium carbonate having a median particle size diameter d₅₀ value from 0.03 μm to 1.0 μm, preferably from 0.06 μm to 1.0 μm, more preferably from 0.1 to 0.85 μm, even more preferably from 0.12 μm to 0.7 μm, and most preferably from 0.15 to 0.5 μm. In this case, the precipitated calcium carbonate may exhibit a BET specific surface area of from 0.5 to 120 m²/g, preferably of from 4 to 50 m²/g, more preferably of from 6 to 35 m²/g and most preferably of from 8 to 20 m²/g, measured by the BET method. For example, the precipitated calcium carbonate may have a median particle size diameter d₅₀ value from 0.12 μm to 0.7 μm, preferably from 0.15 μm to 0.5 μm, a top cut (d₉₈) of 8 μm or less, more preferably of 4 μm or less, and optionally a BET specific surface area of from 4 to 50 m²/g, preferably of from 6 to 35 m²/g, measured by the BET method.

### The Surface-Treatment Layer

According to the present invention, the surface-treated calcium carbonate-containing filler material comprises a surface-treatment layer on at least a part of the surface of said ultrafine calcium carbonate-containing filler material, wherein the surface-treatment layer comprises at least one surface-treatment agent and/or salty reaction products thereof. The at least one surface-treatment agent
i) has a total amount of carbon atoms from C₄ to C₃₄, and
ii) comprises at least one carboxyl group and/or a derivative thereof.

The term “carboxyl group and/or a derivative thereof” is understood to include the free carboxylic acid, a corresponding carboxylic acid ester, a corresponding anhydride, such as an intramolecular anhydride or an intermolecular symmetrical or mixed anhydride, or a corresponding carboxylic acid salt of the at least one surface-treatment agent. In a preferred embodiment, the derivatives of the carboxyl group are selected from the group consisting of intramolecular anhydrides, intermolecular symmetrical anhydrides, intermolecular mixed anhydrides and carboxylic acid salts.

For the purposes of the present invention, a “mixed anhydride” is considered to be an anhydride formed from the hypothetical condensation reaction of two different acid molecules under the extrusion of one molecule of water. Analogously, a “symmetrical anhydride” is considered to be an anhydride formed from the hypothetical condensation reaction of two identical acid molecules under the extrusion of one molecule of water. An “intramolecular anhydride” is understood to be an anhydride formed from the hypothetical intramolecular condensation reaction of two carboxyl groups within one molecule under the formation of a cyclic moiety.

The wording “at least one” carboxyl group and/or a derivative thereof indicates that the at least one surface-treatment agent may comprise one or more carboxyl groups or derivatives thereof. Preferably the at least one surface-treatment agent comprises one or two carboxyl groups or a derivative thereof. It is to be understood that the carbon atoms of the at least one carboxyl group are included in the total amount of carbon atoms of the at least one surface-treatment agent.

The term “salty reaction products” in the meaning of the present invention refers to products obtained by contacting the ultrafine calcium carbonate-containing filler material with one or more carboxylic acids and/or salts or anhydrides thereof. Said salty reaction products may be formed between e.g. the carboxylic acid and reactive molecules or moieties located at the surface of the ultrafine calcium carbonate-containing filler material.

In a preferred embodiment, the surface-treatment layer is present on the ultrafine calcium carbonate-containing filler material in an amount of from 0.1 to 10 wt.-%, preferably from 0.3 to 7.5 wt.-%, more preferably from 0.8 to 5 wt.-%, still more preferably from 1.1 to 4 wt.-%, and most preferably from 2 to 4 wt.-%, based on the total amount of the surface-treated calcium carbonate-containing filler material.

In another preferred embodiment, the surface-treatment layer is present on the ultrafine calcium carbonate-containing filler material in an amount of from 0.25 to 5 mg/m², preferably 0.5 to 4.5 mg/m², even more preferably from 1 to 4 mg/m², and most preferably from 1.3 to 3.5 mg/m², based on the surface area of the ultrafine calcium carbonate-containing filler material as determined by the BET method.

The present inventors found that the surface-treatment layer renders the ultrafine calcium carbonate-containing filler more hydrophobic, thus improving its miscibility and dispersibility within the polymeric matrix. Furthermore, without wishing to be bound to any theory, it is believed that the hydrophobic surface-treatment layer interacts with both the polyethylene phase and the polypropylene phase and is entangled therein, such that the inventive filler can be positioned at the interface of both phases. Thereby, the interfacial adhesion of both phases is enhanced, similar to a Pickering emulsion.

Thus, in a preferred embodiment, the at least one surface-treatment agent has a total amount of carbon atoms from C₈ to C₃₀, preferably from C₁₂ to C₂₆, and comprises at least one carboxyl group and/or a derivative thereof, preferably one or two carboxyl groups or a derivative thereof. More preferably, the at least one surface-treatment agent has a total amount of carbon atoms from C₈ to C₃₀, preferably from C₁₂ to C₂₆, and comprises at least one carboxyl group and/or a derivative thereof, preferably one or two carboxyl groups or a derivative thereof, and is a saturated compound.

In another preferred embodiment, the surface-treatment layer does not comprise an unsaturated compound.

The wording “unsaturated compound” should be understood in that the respective compound comprises at least one unsaturated carbon moiety, such as a carbon-carbon double bond. For example, the respective compound may comprise one unsaturated carbon moiety. However, the respective compound may also comprise more than one unsaturated carbon moiety. For the purposes of the present invention, an “unsaturated carbon moiety” refers to a carbon-carbon double bond or a carbon-carbon triple bond.

In still another preferred embodiment, the surface-treatment layer comprises at least one surface-treatment agent being a saturated surface-treatment agent. Preferably, the saturated surface-treatment agent is selected from the group consisting of
I) at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof,
II) at least one mono-substituted succinic anhydride consisting of succinic anhydride mono-substituted with a group selected from a linear, branched, and cyclic aliphatic group having a total amount of carbon atoms from C₂ to C₃₀ in the substituent and/or a salt or an acid thereof,
III) salty reaction products of the materials according to I) and II), and
IV) mixtures of the materials according to I) to III).

The term “carboxylic acid and/or a salt thereof” refers to carboxylic acids, carboxylic acid salts and their mixtures. The term “carboxylic acid” in the sense of the present invention is understood to refer to a “monocarboxylic acid”, i.e. the carboxylic acid is characterized in that a single carboxyl group is present. The term “monocarboxylic acid and/or a salt thereof” refers to monocarboxylic acids and monocarboxylic acid salts. The term “dicarboxylic acid and/or a salt or anhydride thereof” refers to dicarboxylic acids, dicarboxylic acid salts, dicarboxylic anhydrides and their mixtures, wherein a “dicarboxylic anhydride” is understood to be an acyclic or cyclic anhydride.

The term “succinic anhydride”, also called dihydro-2,5-furandione, succinic acid anhydride or succinyl oxide, has the molecular formula C₄H₄O₃ and is the acid anhydride of succinic acid.

The term “succinic anhydride” containing compound refers to a compound containing succinic anhydride. The term “succinic anhydride”, also called dihydro-2,5-furandione, succinic acid anhydride or succinyl oxide, has the molecular formula C₄H₄O₃ and is the acid anhydride of succinic acid.

The term “mono-substituted” succinic anhydride containing compound in the meaning of the present invention refers to a succinic anhydride wherein a hydrogen atom is substituted by another substituent.

The term “succinic acid” containing compound refers to a compound containing succinic acid. The term “succinic acid” has the molecular formula C₄H₆O₄.

The term “mono-substituted” succinic acid in the meaning of the present invention refers to a succinic acid wherein a hydrogen atom is substituted by another substituent.

The term “succinic acid salt” containing compound refers to a compound containing succinic acid, wherein the active acid groups are partially or completely neutralized. The term “partially neutralized” succinic acid salt containing compound refers to a degree of neutralization of the active acid groups in the range from 40 and 95 mol-%, preferably from 50 to 95 mol-%, more preferably from 60 to 95 mol-% and most preferably from 70 to 95 mol-%. The term “completely neutralized” succinic acid salt containing compound refers to a degree of neutralization of the active acid groups of >95 mol-%, preferably of >99 mol-%, more preferably of >99.8 mol-% and most preferably of 100 mol-%. Preferably, the active acid groups are partially or completely neutralized.

The succinic acid salt containing compound comprising unsaturated carbon moieties is preferably a compound selected from the group consisting of sodium, potassium, calcium, magnesium, lithium, strontium, primary amine, secondary amine, tertiary amine and/or ammonium salts thereof, whereby the amine salts are linear or cyclic. It is appreciated that one or both acid groups can be in the salt form, preferably both acid groups are in the salt form.

The term “mono-substituted” succinic acid salt in the meaning of the present invention refers to a succinic acid salt wherein a hydrogen atom is substituted by another substituent.

The terms “alkyl” and “aliphatic” in the meaning of the present invention refers to a linear or branched, saturated organic compound composed of carbon and hydrogen. For example, “alkyl carboxylic acids” are composed of linear or branched, saturated hydrocarbon chains containing a pendant carboxylic acid group.

A linear group is understood to be a group, wherein each carbon atom has a direct bond to 1 or 2 other carbon atoms. A branched group is understood to be a group, wherein at least one carbon atom has a direct bond to 3 or 4 other carbon atoms. A saturated group is understood to be a group, which does not contain a carbon-carbon multiple bond, i.e., a carbon-carbon double bond or a carbon-carbon triple bond. An unsaturated group is understood to be a group, which contains at least one carbon-carbon multiple bond, i.e., a carbon-carbon double bond or a carbon-carbon triple bond. A cyclic group is understood to be a group, wherein at least three carbon atoms are linked together in a way such as to form a ring. An acyclic group is understood to be a group, wherein no ring is present.

In yet another embodiment, the surface-treatment layer comprises at least one surface-treatment agent being an unsaturated surface-treatment agent selected from the group consisting of
I) at least one mono-substituted succinic anhydride consisting of succinic anhydride mono-substituted with a group selected from a linear, branched and cyclic unsaturated group having a total amount of carbon atoms from C₂ to C₃₀ in the substituent and/or a salt or an acid thereof, and
II) salty reaction products of the materials according to I).

The term “alkenyl” in the meaning of the present invention refers to a linear or branched, unsaturated organic compound composed of carbon and hydrogen. Said organic compound further contains at least one double bond in the substituent, preferably one double bond. In other words, “alkenyl carboxylic acids” are composed of linear or branched, unsaturated hydrocarbon chains containing a pendant carboxylic acid group. It is appreciated that the term “alkenyl” in the meaning of the present invention includes the cis and trans isomers.

In the following, the saturated and unsaturated surface-treatment agents will be described more in detail.

According to one embodiment of the present invention, the surface-treatment composition comprises a saturated surface-treatment agent, which is at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof and/or salty reaction products thereof.

The aliphatic carboxylic acid in the meaning of the present invention may be selected from one or more linear chain, branched chain, saturated, and/or alicyclic carboxylic acids.

In one embodiment of the present invention, the aliphatic linear or branched carboxylic acid and/or salt thereof is selected from saturated unbranched carboxylic acids, preferably selected from the group of carboxylic acids consisting of pentanoic acid, hexanoic acid, heptanoic acid, octanoic acid, nonanoic acid, decanoic acid, undecanoic acid, lauric acid, tridecanoic acid, myristic acid, pentadecanoic acid, palmitic acid, heptadecanoic acid, stearic acid, nonadecanoic acid, arachidic acid, heneicosylic acid, behenic acid, tricosylic acid, lignoceric acid, their salts, their anhydrides and mixtures thereof.

In another embodiment of the present invention, the aliphatic linear or branched carboxylic acid and/or salt thereof is selected from the group consisting of octanoic acid, decanoic acid, lauric acid, myristic acid, palmitic acid, stearic acid, arachidic acid and mixtures thereof. Preferably, the aliphatic carboxylic acid is selected from the group consisting of myristic acid, palmitic acid, stearic acid, their salts and mixtures thereof.

Preferably, the aliphatic carboxylic acid and/or a salt thereof is stearic acid and/or a stearic acid salt.

According to a preferred embodiment of the present invention, the surface-treatment composition comprises a saturated surface-treatment agent, which is at least one mono-substituted succinic anhydride consisting of succinic anhydride mono-substituted with a group selected from a linear, branched, aliphatic and cyclic group having a total amount of carbon atoms from C₂ to C₃₀ in the substituent and/or salts thereof and/or salty reaction products thereof.

Accordingly, it should be noted that the at least one mono-substituted succinic anhydride may be one kind of mono-substituted succinic anhydride. Alternatively, the at least one mono-substituted succinic anhydride may be a mixture of two or more kinds of mono-substituted succinic anhydride. For example, the at least one mono-substituted succinic anhydride may be a mixture of two or three kinds of mono-substituted succinic anhydride, like two kinds of mono-substituted succinic anhydride.

In one embodiment of the present invention, the at least one mono-substituted succinic anhydride is one kind of mono-substituted succinic anhydride.

It is appreciated that the at least one mono-substituted succinic anhydride represents a surface treatment agent and consists of succinic anhydride mono-substituted with a group selected from any linear, branched, aliphatic, and cyclic group having a total amount of carbon atoms from C₂ to C₃₀ in the substituent.

In one embodiment of the present invention, the at least one mono-substituted succinic anhydride consists of succinic anhydride mono-substituted with a group selected from a linear, branched, and cyclic group aliphatic having a total amount of carbon atoms from C₃ to C₂₀ in the substituent. For example, the at least one mono-substituted succinic anhydride consists of succinic anhydride mono-substituted with a group selected from a linear, branched, and cyclic aliphatic group having a total amount of carbon atoms from C₄ to C₁₈ in the substituent.

In one embodiment of the present invention, the at least one mono-substituted succinic anhydride consists of succinic anhydride mono-substituted with one group being a linear and aliphatic group having a total amount of carbon atoms from C₂ to C₃₀, preferably from C₃ to C₂₀ and most preferably from C₄ to C₁₈ in the substituent. Additionally or alternatively, the at least one mono-substituted succinic anhydride consists of succinic anhydride mono-substituted with one group being a branched and aliphatic group having a total amount of carbon atoms from C₂ to C₃₀, preferably from C₃ to C₂₀ and most preferably from C₄ to C₁₈ in the substituent.

Thus, it is preferred that the at least one mono-substituted succinic anhydride consists of succinic anhydride mono-substituted with one group being a linear or branched, alkyl group having a total amount of carbon atoms from C₂ to C₃₀, preferably from C₃ to C₂₀ and most preferably from C₄ to C₁₈ in the substituent.

For example, the at least one mono-substituted succinic anhydride consists of succinic anhydride mono-substituted with one group being a linear alkyl group having a total amount of carbon atoms from C₂ to C₃₀, preferably from C₃ to C₂₀ and most preferably from C₄ to C₁₈ in the substituent. Additionally or alternatively, the at least one mono-substituted succinic anhydride consists of succinic anhydride mono-substituted with one group being a branched alkyl group having a total amount of carbon atoms from C₂ to C₃₀, preferably from C₃ to C₂₀ and most preferably from C₄ to C₁₈ in the substituent.

In one embodiment of the present invention, the at least one mono-substituted succinic anhydride is at least one linear or branched alkyl mono-substituted succinic anhydride. For example, the at least one alkyl mono-substituted succinic anhydride is selected from the group comprising ethylsuccinic anhydride, propylsuccinic anhydride, butylsuccinic anhydride, triisobutyl succinic anhydride, pentylsuccinic anhydride, hexylsuccinic anhydride, heptylsuccinic anhydride, octylsuccinic anhydride, nonylsuccinic anhydride, decyl succinic anhydride, dodecyl succinic anhydride, hexadecanyl succinic anhydride, octadecanyl succinic anhydride, and mixtures thereof.

In one embodiment of the present invention, the at least one alkyl mono-substituted succinic anhydride is selected from the group comprising butylsuccinic anhydride, hexylsuccinic anhydride, heptylsuccinic anhydride, octylsuccinic anhydride, hexadecanyl succinic anhydride, octadecanyl succinic anhydride, and mixtures thereof.

In one embodiment of the present invention, the at least one mono-substituted succinic anhydride is a mixture of two or more kinds of alkyl mono-substituted succinic anhydrides. For example, the at least one mono-substituted succinic anhydride is a mixture of two or three kinds of alkyl mono-substituted succinic anhydrides.

According to one embodiment of the present invention, the surface-treatment composition comprises an unsaturated surface-treatment agent selected from the group consisting of at least one unsaturated mono-substituted succinic anhydride consisting of succinic anhydride mono-substituted with a group selected from a linear, branched and cyclic unsaturated group having a total amount of carbon atoms from C₂ to C₃₀ in the substituent and/or a salt or an acid thereof, and salty reaction products thereof.

In another preferred embodiment of the present invention, the unsaturated mono-substituted succinic anhydride is at least one linear or branched alkenyl mono-substituted succinic anhydride compound comprising unsaturated carbon moieties. For example, the at least one alkenyl mono-substituted succinic anhydride is selected from the group comprising ethenylsuccinic anhydride, propenylsuccinic anhydride, butenylsuccinic anhydride, triisobutenyl succinic anhydride, pentenylsuccinic anhydride, hexenylsuccinic anhydride, heptenylsuccinic anhydride, octenylsuccinic anhydride, nonenylsuccinic anhydride, decenyl succinic anhydride, dodecenyl succinic anhydride, hexadecenyl succinic anhydride, octadecenyl succinic anhydride, and mixtures thereof.

In one embodiment of the present invention, the at least one alkenyl mono-substituted succinic anhydride is selected from the group comprising hexenylsuccinic anhydride, octenylsuccinic anhydride, hexadecenyl succinic anhydride, octadecenyl succinic anhydride, and mixtures thereof.

In one embodiment of the present invention, the unsaturated mono-substituted succinic anhydride is one alkenyl mono-substituted succinic anhydride.

In one embodiment of the present invention, the one alkenyl mono-substituted succinic anhydride is linear octadecenyl succinic anhydride such as n-octadecenyl succinic anhydride. In another embodiment of the present invention, the one alkenyl mono-substituted succinic anhydride is linear octenylsuccinic anhydride such as n-octenylsuccinic anhydride.

In one embodiment of the present invention, the unsaturated mono-substituted succinic anhydride is a mixture of two or more kinds of alkenyl mono-substituted succinic anhydrides. For example, the mono-substituted succinic anhydride is a mixture of two or three kinds of alkenyl mono-substituted succinic anhydrides.

If the unsaturated mono-substituted succinic anhydride is a mixture of two or more kinds of alkenyl mono-substituted succinic anhydrides, one alkenyl mono-substituted succinic anhydride is linear or branched octadecenyl succinic anhydride, while each further alkenyl mono-substituted succinic anhydride is selected from ethenylsuccinic anhydride, propenylsuccinic anhydride, butenylsuccinic anhydride, pentenylsuccinic anhydride, hexenylsuccinic anhydride, heptenylsuccinic anhydride, nonenylsuccinic anhydride, hexadecenyl succinic anhydride and mixtures thereof. For example, the unsaturated mono-substituted succinic anhydride is a mixture of two or more kinds of alkenyl mono-substituted succinic anhydrides, wherein one alkenyl mono-substituted succinic anhydride is linear octadecenyl succinic anhydride and each further alkenyl mono-substituted succinic anhydride is selected from ethenylsuccinic anhydride, propenylsuccinic anhydride, butenylsuccinic anhydride, pentenylsuccinic anhydride, hexenylsuccinic anhydride, heptenylsuccinic anhydride, nonenylsuccinic anhydride, hexadecenyl succinic anhydride and mixtures thereof. Alternatively, the unsaturated mono-substituted succinic anhydride is a mixture of two or more kinds of alkenyl mono-substituted succinic anhydrides, wherein one alkenyl mono-substituted succinic anhydride is branched octadecenyl succinic anhydride and each further alkenyl mono-substituted succinic anhydride is selected from ethenylsuccinic anhydride, propenylsuccinic anhydride, butenylsuccinic anhydride, pentenylsuccinic anhydride, hexenylsuccinic anhydride, heptenylsuccinic anhydride, nonenylsuccinic anhydride, hexadecenyl succinic anhydride and mixtures thereof.

For example, the unsaturated mono-substituted succinic anhydride is a mixture of two or more kinds of alkenyl mono-substituted succinic anhydrides comprising one or more hexadecenyl succinic anhydride, like linear or branched hexadecenyl succinic anhydride(s), and one or more octadecenyl succinic anhydride, like linear or branched octadecenyl succinic anhydride(s).

In one embodiment of the present invention, the unsaturated mono-substituted succinic anhydride is a mixture of two or more kinds of alkenyl mono-substituted succinic anhydrides comprising linear hexadecenyl succinic anhydride(s) and linear octadecenyl succinic anhydride(s). Alternatively, the unsaturated mono-substituted succinic anhydride is a mixture of two or more kinds of alkenyl mono-substituted succinic anhydrides comprising branched hexadecenyl succinic anhydride(s) and branched octadecenyl succinic anhydride(s). For example, the one or more hexadecenyl succinic anhydride is linear hexadecenyl succinic anhydride like n-hexadecenyl succinic anhydride and/or branched hexadecenyl succinic anhydride like 1-hexyl-2-decenyl succinic anhydride. Additionally or alternatively, the one or more octadecenyl succinic anhydride is linear octadecenyl succinic anhydride like n-octadecenyl succinic anhydride and/or branched octadecenyl succinic anhydride like iso-octadecenyl succinic anhydride and/or 1-octyl-2-decenyl succinic anhydride.

If the unsaturated mono-substituted succinic anhydride is a mixture of two or more kinds of alkenyl mono-substituted succinic anhydrides, it is appreciated that one alkenyl mono-substituted succinic anhydride is present in an amount of from 20 to 60 wt.-% and preferably of from 30 to 50 wt.-%, based on the total weight of the mono-substituted succinic anhydride provided.

For example, if the unsaturated mono-substituted succinic anhydride is a mixture of two or more kinds of alkenyl mono-substituted succinic anhydrides comprising one or more hexadecenyl succinic anhydride(s), like linear or branched hexadecenyl succinic anhydride(s), and one or more octadecenyl succinic anhydride(s), like linear or branched hexadecenyl succinic anhydride(s), it is preferred that the one or more octadecenyl succinic anhydride(s) is present in an amount of from 20 to 60 wt.-% and preferably of from 30 to 50 wt.-%, based on the total weight of the mono-substituted succinic anhydride.

It is also appreciated that the unsaturated mono-substituted succinic anhydride may be a mixture of alkyl mono-substituted succinic anhydrides and alkenyl mono-substituted succinic anhydrides.

In another embodiment, the unsaturated surface-treatment agent may be an unsaturated mono-substituted succinic acid or an unsaturated mono-substituted succinic acid salt, wherein the unsaturated mono-substituted succinic acid or the unsaturated mono-substituted succinic acid salt is derived from the unsaturated mono-substituted succinic anhydrides as described hereinabove.

It is to be understood that the surface-treatment layer of the surface-treated calcium carbonate-containing filler material is formed by contacting the ultrafine calcium carbonate-containing filler material with the at least one surface treatment agent. That is, a chemical reaction may take place between the ultrafine calcium carbonate-containing filler material and the surface treatment agent. In other words, the surface-treatment layer comprises the surface treatment agent and/or salty reaction products thereof.

For example, if the surface-treatment layer is formed by contacting the ultrafine calcium carbonate-containing filler material with at least one saturated aliphatic linear or branched carboxylic acid and/or a salt thereof, the surface-treatment layer may further comprise a salt formed from the reaction of the at least one saturated aliphatic linear or branched carboxylic acid and/or salt with the ultrafine calcium carbonate-containing filler material. Likewise, if the surface-treatment layer is formed by contacting the ultrafine calcium carbonate-containing filler material with stearic acid, the surface-treatment layer may further comprise a salt formed from the reaction of stearic acid with the ultrafine calcium carbonate-containing filler material. Analogous reactions may take place when using alternative surface treatment agents according to the present invention.

According to one embodiment, the salty reaction product(s) of the at least one surface-treatment agent are one or more calcium and/or magnesium salts thereof.

According to one embodiment, the salty reaction product(s) of the at least one surface-treatment agent formed on at least a part of the surface of the ultrafine calcium carbonate-containing filler material are one or more calcium salts and/or one or more magnesium salts thereof.

According to one embodiment, the molar ratio of the at least one surface-treatment agent to the salty reaction product(s) thereof is from 99.9:0.1 to 0.1:99.9, preferably from 70:30 to 90:10.

According to a preferred embodiment of the present invention, the surface-treated calcium carbonate-containing filler material comprises, and preferably consists of, the ultrafine calcium carbonate-containing filler material and a treatment layer comprising at least one saturated surface-treatment agent and/or salty reaction products thereof. The treatment layer is formed on at least a part of the surface, preferably on the whole surface, of said ultrafine calcium carbonate-containing filler material.

In one embodiment of the present invention, the treatment layer formed on the surface of the ultrafine calcium carbonate-containing filler material comprises the saturated surface-treatment agent and/or salty reaction product(s) thereof obtained from contacting the calcium carbonate-containing filler material with the saturated surface-treatment agent.

In a particularly preferred embodiment of the present invention, the surface-treated calcium carbonate-containing filler material comprises, and preferably consists of, the ultrafine calcium carbonate-containing filler material and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof.

Preferably, the surface-treated calcium carbonate-containing filler material comprises, and preferably consists of, the ultrafine calcium carbonate-containing filler material and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, wherein the treatment layer does not comprise an unsaturated compound. For example, the surface-treated calcium carbonate-containing filler material consists of the ultrafine calcium carbonate-containing filler material and a treatment layer consisting of at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof.

In an exemplary embodiment of the present invention, the surface-treated calcium carbonate-containing filler material comprises, and preferably consists of, the ultrafine calcium carbonate-containing filler material, having a weight median particle size (d₅₀) value in the range from 0.06 μm to 1.0 μm, preferably from 0.1 to 0.85 μm, more preferably from 0.12 μm to 0.7 μm, most preferably from 0.15 to 0.5 μm, and/or a top cut (d₉₈) value of 8 μm or less, preferably 6 μm or less, more preferably 4 μm or less, and most preferably 2.5 μm or less; and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound.

For example, the surface-treated calcium carbonate-containing filler material comprises, and preferably consists of, the ultrafine calcium carbonate-containing filler material, having a weight median particle size (d₅₀) value in the range from 0.15 to 0.5 μm, and a top cut (d₉₈) value of 8 μm or less, preferably 6 μm or less, more preferably 4 μm or less, and most preferably 2.5 μm or less; and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, preferably wherein the treatment layer does not comprise an unsaturated compound.

The surface-treated calcium carbonate-containing filler material according to the present invention has excellent surface characteristics. The surface-treated calcium carbonate-containing filler material preferably has
i) a hydrophilicity in the range from 0.01 to 4, preferably from 0.02 to 3, more preferably 0.03 to 2, and most preferably from 0.04 to 1, indicated as the volumetric ratio of water:ethanol, measured at +23° C. (±2° C.) with the sedimentation method, and/or
ii) a moisture pick up susceptibility from 0.01 to 5 mg/g, preferably from 0.02 to 4 mg/g, more preferably from 0.03 to 2 mg/g, and most preferably from 0.03 to 1.2 mg/g.

The “hydrophilicity” of a mineral filler product is evaluated at +23° C. by determining the minimum water to ethanol ratio in a volume/volume based water/ethanol-mixture needed for the settling of the majority of said mineral filler product, where said mineral filler product is deposited on the surface of said water/ethanol-mixture by passage through a house hold tea sieve. The volume/volume base is related to the volumes of both separate liquids before blending them together and does not take into account the volume contraction of the blend. The evaluation at +23° C. refers to a temperature of +23° C.±1° C.

An 8:2 volumetric ratio of a water/ethanol-mixture has typically a surface tension of 41 mN/m and a 6:4 volumetric ratio of a water/ethanol-mixture has typically a surface tension of 26 mN/m measured at +23° C. as described in the “Handbook of Chemistry and Physics”, 84th edition, David R. Lide, 2003 (first edition 1913).

The “moisture pickup susceptibility” of a material refers to the amount of moisture adsorbed on the surface of said material within a certain time upon exposure to a defined humid atmosphere and is expressed in mg/g. The “normalized moisture pickup susceptibility” of a material refers to the amount of moisture adsorbed on the surface of said material within a certain time upon exposure to a defined humid atmosphere and is expressed in mg/m².

The moisture pick up susceptibility (in mg/g) is determined by exposure of a sample to an atmosphere of 10 and 85% relative humidity, respectively, for 2.5 hours at a temperature of 23° C. (±2° C.). For this purpose, the sample is first kept at an atmosphere of 10% relative humidity for 2.5 hours, then the atmosphere is changed to 85% relative humidity at which the sample is kept for another 2.5 hours. The weight increase between 10 and 85% relative humidity is then used to calculate the moisture pick-up susceptibility in mg moisture/g of sample. The moisture pick up susceptibility in mg/g divided by the specific surface area in m²/g (BET method) corresponds to the “normalized moisture pick up susceptibility” expressed in mg/m² of sample.

In another preferred embodiment of the present invention, the surface-treated calcium carbonate-containing filler material may have a high volatile onset temperature, for example ≥250° C., preferably of ≥260° C., and most preferably of ≥270° C., and a high thermal stability, e.g. up to temperatures of 250° C., 270° C., or 290° C. Additionally or alternatively, the surface-treated calcium carbonate-containing filler material may have total volatiles between 25° C. and 400° C. of less than and preferably of less than 7.5% %, more preferably less than 5% and most preferably less than 4% by mass, e.g., of from 0.04 to 10% by mass, preferably from 0.08 to 7.5% by mass, more preferably from 0.1 to 5% by mass and most preferably from 0.15 to 4%.

The term “volatile onset temperature” in the meaning of the present document refers to the temperature at which volatiles—including volatiles introduced or formed during a preparation process such as grinding agents (unless indicated otherwise)—begin to evolve as observed by thermogravimetric analysis (TGA).

In the present invention, thermogravimetric analysis (TGA) is performed using a Mettler Toledo TGA/DSC3+ based on a sample size of 250±50 mg in a 900 μL crucible and scanning temperatures from 25 to 400° C. at a rate of 20° C./minute under an air flow of 80 ml/min.

The skilled man will be able to determine the “volatile onset temperature” by analysis of the TGA curve as follows: the first derivative of the TGA curve is obtained and the inflection points thereon between 150 and 400° C. are identified. Of the inflection points having a tangential slope value of greater than 45° relative to a horizontal line, the one having the lowest associated temperature above 200° C. is identified. The temperature value associated with this lowest temperature inflection point of the first derivative curve is the “volatile onset temperature”.

For the purpose of the present application, the “total volatiles” associated with mineral fillers and evolved over a temperature range of 25 to 400° C. is characterized according to % mass loss of the mineral filler sample over a temperature range as read on a thermogravimetric (TGA) curve.

TGA analytical methods provide information regarding losses of mass and volatile onset temperatures with great accuracy, and is common knowledge; it is, for example, described in “Principles of Instrumental analysis”, fifth edition, Skoog, Holler, Nieman, 1998 (first edition 1992) in Chapter 31 pages 798 to 800, and in many other commonly known reference works. In the present invention, thermogravimetric analysis (TGA) is performed using a Mettler Toledo TGA/DSC3+ based on a sample of 250±50 mg in a 900 μL crucible and scanning temperatures from 25 to 400° C. at a rate of 20° C./minute under an air flow of 80 ml/min.

It is to be understood that the particle size or properties of the ultrafine calcium carbonate-containing filler material is not altered or only slightly altered by the surface-treatment. Thus, in a preferred embodiment, the surface-treated calcium carbonate-containing filler material has a weight median particle size d₅₀ from 0.03 μm to 1.0 μm, preferably from 0.06 μm to 1.0 μm, more preferably from 0.1 to 0.85 μm, even more preferably from 0.12 μm to 0.7 μm and most preferably from 0.15 to 0.5 μm. Accordingly, the surface-treated calcium carbonate-containing filler material may have a top cut (d₉₈) of 10 μm or less, preferably 8 μm or less, preferably 6 μm or less, more preferably 4 μm or less, and most preferably 2.5 μm or less.

Furthermore, the surface-treated calcium carbonate-containing filler material may have a BET specific surface area of from 0.5 and 120 m²/g, preferably from 4 to 50 m²/g, more preferably from 6 to 35 m²/g, and most preferably from 8 to 20 m²/g, as measured by the BET method according to ISO 9277:2010.

According to one embodiment of the present invention, the surface-treated calcium carbonate-containing filler material has a weight median particle size d₅₀ from 0.03 μm to 1.0 μm and/or a top cut (d₉₈) of 10 μm or less and/or a specific surface area (BET) of from 0.5 to 120 m²/g, as measured by the BET method.

For example, the surface-treated calcium carbonate-containing filler material may have a median particle size diameter d₅₀ value from 0.12 μm to 0.7 μm, preferably from 0.15 μm to 0.5 μm, a top cut (d₉₈) of 8 μm or less, more preferably of 4 μm or less, and optionally a BET specific surface area of from 4 to 50 m²/g, preferably of from 6 to 35 m²/g, measured by the BET method.

### The Filled Polymer Composition

In a first aspect of the present invention, a filled polymer composition is provided. The filled polymer composition comprises
a) at least one polyethylene polymer,
b) at least one polypropylene polymer, and
c) a surface-treated calcium carbonate-containing filler material in an amount from 5 wt.-% to 70 wt.-%, based on the total weight of the composition,
   wherein the surface-treated calcium carbonate-containing filler material comprises
an ultrafine calcium carbonate-containing filler material having
   i) a weight median particle size (d₅₀) value in the range from 0.03 μm to 1.0 μm and
   ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
   wherein the at least one surface-treatment agent
i) has a total amount of carbon atoms from C₄ to C₃₄, and
ii) comprises at least one carboxyl group and/or a derivative thereof.

The at least one polyethylene polymer, the at least one polypropylene polymer, the surface-treated calcium carbonate-containing filler material, the ultrafine calcium carbonate-containing filler material and the surface-treatment layer have been described in detail hereinabove.

In a preferred embodiment of the present invention, the at least one polyethylene polymer and the at least one polypropylene polymer are at least partially derived from waste polymers. Thus, the filled polymer composition may comprise a mixture of virgin and recycled polymers. For example, the filled polymer composition may comprise at least one polyethylene polymer being derived from waste polymers and at least one polypropylene polymer being derived from waste polymers in a combined amount of at least 20 wt.-%, preferably at least 50 wt.-%, more preferably at least 70 wt.-%, still more preferably at least 85 wt.-%, and most preferably at least 95 wt.-%, based on the total amount of polymer in the filled polymer composition. In other words, the filled polymer composition may comprise a total amount of polymer being derived from waste polymers of at least 20 wt.-%, preferably at least 50 wt.-%, more preferably at least 70 wt.-%, still more preferably at least 85 wt.-%, and most preferably at least 95 wt.-%, based on the total amount of polymer in the filled polymer composition.

In a preferred embodiment of the present invention, the filled polymer composition comprises a polymer mixture comprising the at least one polyethylene polymer and the at least one polypropylene polymer. Preferably, the polymer mixture is derived from waste polymers comprising the at least one polyethylene polymer and the at least one polypropylene polymer. The polymer mixture being “derived from” waste polymers is understood in that the polymer mixture is obtained by a purification process. Suitable purification processes are described hereinabove within context of the at least one polyethylene polymer. It is to be stressed that the separation of polyethylene polymers and polypropylene polymers in such process may be incomplete, such that the polymer mixture indeed is a mixture of the at least one polyethylene polymer and the at least one polypropylene polymer.

Furthermore, the polymer mixture may comprise further polymers, e.g., polyethylene terephthalate (PET), polytrimethylene terephthalate (PTT), polybutylene terephthalate (PBT), polyethylene naphthalate (PEN), but also degradable polyesters, such as polylactic acid (polylactide, PLA) and polyethylene-2,5-furandicarboxylate, polyvinyl chloride, polyvinylidene chloride (PVDC), polyvinylidene fluoride (PVDF) and polytetrafluoroethylene (PTFE), polybutadiene, polyacrylonitrile, polymethylmethacrylate, polyamides, polyurethanes, and mixtures thereof.

In one embodiment of the present invention, the at least one polypropylene polymer is present in the inventive filled polymer composition in an amount from 0.5 to 99 wt.-%, preferably from 1 to 70 wt.-%, more preferably from 1 wt.-% to 50 wt.-%, still more preferably from 1 to 30 wt.-%, even more preferably from 2 to 30 wt.-%, and most preferably from 5 to 30 wt.-%, based on the total weight of the polymer in the filled polymer composition. Additionally or alternatively, the at least one polyethylene polymer is present in the inventive filled polymer composition in an amount from 1.0 to 99.5 wt.-%, preferably from 30 to 99 wt.-%, more preferably from 50 wt.-% to 99 wt.-%, still more preferably from 70 to 99 wt.-%, even more preferably from 70 to 98 wt.-%, and most preferably from 70 to 95 wt.-%, based on the total weight of the polymer in the filled polymer composition. In the case that the at least one polyethylene polymer and the at least one polypropylene polymer are at least partially derived from waste polymers, it is to be understood that the amounts of the at least one polyethylene polymer and the at least one polypropylene polymer are determined at least partially by the source and/or composition of the waste polymer. In view thereof, it is appreciated that the invention is not limited to specific amounts of polyethylene polymer and polypropylene polymer.

As an illustrative example, the filled polymer composition may comprise a polymer mixture being derived from waste polymers, which comprises, e.g., from 50 to 99 wt.-%, preferably from 70 to 99 wt.-%, more preferably from 70 to 98 wt.-%, most preferably from 70 to 95 wt.-%, based on the total weight of the polymer mixture, of at least one polyethylene polymer and, e.g., from 1 to 50 wt.-%, preferably from 1 to 30 wt.-%, more preferably from 2 to 30 wt.-%, most preferably from 5 to 30 wt.-%, based on the total weight of the polymer mixture, of at least one polypropylene polymer. The polymer mixture being derived from waste polymers may be present in an amount of at least 20 wt.-%, preferably at least 50 wt.-%, more preferably at least 70 wt.-%, still more preferably at least 85 wt.-%, and most preferably at least 95 wt.-%, based on the total amount of polymer in the filled polymer composition. Additionally, the filled polymer composition may comprise at least one further polyethylene polymer being a virgin polymer and/or at least one further polypropylene polymer being a virgin polymer, e.g., such that the polymer mixture and the at least one further polyethylene polymer being a virgin polymer and/or at least one further polypropylene polymer being a virgin polymer add up to 100 wt.-%, based on the total amount of polymer in the filled polymer composition.

Thus, in a preferred embodiment of the present invention, the filled polymer composition comprises a total amount of polymer being derived from waste polymers of at least 20 wt.-%, preferably at least 50 wt.-%, more preferably at least 70 wt.-%, still more preferably at least 85 wt.-%, and most preferably at least 95 wt.-%, based on the total amount of polymer in the filled polymer composition.

Preferably, the inventive filled polymer composition comprises the at least one polyethylene polymer and the at least one polypropylene polymer in a combined amount of at least 50 wt.-%, preferably at least 80 wt.-%, more preferably at least 95 wt.-%, and most preferably at least 98 wt.-%, based on the total weight of the polymer in the filled polymer composition.

In one embodiment of the present invention, the surface-treated calcium carbonate-containing filler material is present in the inventive filled polymer composition in an amount from 5 wt.-% to 70 wt.-%, preferably from 5 wt.-% to 60 wt.-%, more preferably 7 wt.-% to 40 wt.-%, based on the total weight of the filled polymer composition.

The inventive filled polymer composition may comprise at least one further polymer. The at least one further polymer may be selected from the group comprising polystyrene, polyesters, such as polyethylene terephthalate (PET), polytrimethylene terephthalate (PTT), polybutylene terephthalate (PBT), polyethylene naphthalate (PEN), but also degradable polyesters, such as polylactic acid (polylactide, PLA) and polyethylene-2,5-furandicarboxylate, polyvinyl chloride, polyvinylidene chloride (PVDC), polyvinylidene fluoride (PVDF) and polytetrafluoroethylene (PTFE), polybutadiene, polyacrylonitrile, polymethylmethacrylate, polyamides, polyurethanes, and mixtures thereof.

Preferably, the at least one further polymer is selected from the group comprising polystyrene, polyesters, preferably polyethylene terephthalate, polylactic acid, polyhydroxybutyrate and polyethylene-2,5-furandicarboxylate, polyvinyl chloride, polybutadiene, polyacrylonitrile, polymethylmethacrylate, polyamides, polyurethanes, and mixtures thereof.

The at least one further polymer may be present in the inventive filled polymer composition in an amount of at most 50 wt.-%, preferably at most 30 wt.-%, more preferably at most 15 wt.-%, and most preferably at most 5 wt.-%, based on the total amount of the polymer in the filled polymer composition.

In a preferred embodiment of the present invention, the at least one further polymer is derived from waste polymers. For example, the at least one further polymer is contained in the polymer mixture being derived from waste polymers as described hereinabove. In other words, said polymer mixture may be contaminated by the at least one further polymer, e.g., due to an incomplete purification process. In said embodiment, it is preferred that the inventive polymer composition comprises the at least one further polymer in an amount of at most 5 wt.-%, preferably at most 2 wt.-%, based on the total amount of polymer in the filled polymer composition.

Additionally or alternatively, the inventive filled polymer composition may further comprise at least one additive selected from the group consisting of further fillers, preferably selected from the group consisting of talc, mica, kaolin, bentonite or mixtures thereof, UV-absorbers, light stabilizers, processing stabilizers, antioxidants, heat stabilizers, nucleating agents, metal deactivators, impact modifiers, plasticizers, lubricants, rheology modifiers, processing aids, pigments, dyes, optical brighteners, antimicrobials, antistatic agents, slip agents, anti-block agents, coupling agents, dispersants, compatibilizers, oxygen scavengers, acid scavengers, markers, antifogging agents, surface modifiers, flame retardants, blowing agents, smoke suppressors, or mixtures of the foregoing additives. The at least one additive may be present in an amount of up to 30 wt.-%, preferably up to 5 wt.-%, more preferably up to 2 wt.-%, based on the total weight of the filled polymer composition. The total amount of additives may be up to 35 wt.-%, preferably up to 5 wt.-%, more preferably up to 2 wt.-%, based on the total weight of the filled polymer composition.

The at least one additive may be added to the inventive filled polymer composition on purpose and/or may be present due to the at least one polyethylene polymer and/or the at least one polypropylene polymer being derived from waste polymers.

According to one embodiment, the polymer composition comprises a further filler. The further filler may be selected from the group comprising carbon black, silica, ground natural calcium carbonate, precipitated calcium carbonate, nanofillers, graphite, clay, talc, diatomaceous earth, barium sulfate, titanium dioxide, wollastonite, and mixtures thereof. Preferably, the further filler is selected from the group consisting of talc, mica, kaolin, bentonite or mixtures thereof. The further filler may be present in the inventive filled polymer composition in an amount of at most 30 wt.-%, more preferably at most 15 wt.-%, and most preferably at most 5 wt.-%, based on the total amount of the filled polymer composition.

It is to be understood that the further filler can be distinguished from the surface-treated calcium carbonate-containing filler material, e.g., by its chemical composition and/or by its particle size. In other words, if the at least one further filler is selected from ground natural calcium carbonate or precipitated calcium carbonate, said further filler has a weight median particle size (d₅₀) value of more than 1.0 μm and/or a top cut (d₉₈) value of more than 10 μm and/or does not comprise a surface-treatment layer as defined hereinabove.

In one embodiment, the filled polymer composition comprises a peroxide reagent or a reaction product thereof. The peroxide reagent can be selected from a very wide range, including peresters, perketals, hydroperoxides, peroxydicarbonates, diacyl peroxides and ketone peroxides. Examples of such peroxides include t-butyl peroctanoate, perbenzoate, methyl ethyl ketone peroxide, cyclohexanone peroxide, acetyl acetone peroxide, dibenzoyl peroxide, bis(4-t-butyl-cyclohexyl) peroxydicarbonate, dicumyl peroxide, 1,1-bis(tert-butylperoxy)-3,3,5-trimethylcyclohexane, 2,5-bis-(t-butylperoxy)-2,5-dimethylhexane, 2,5-bis-(t-butylperoxy)-2,5-dimethylhexyne, or α,α′-bis(t-butylperoxy)diisopropylbenzene, diisopropyl peroxydicarbonate, 1,1-bis(tert-hexylperoxy)-3,5,5-trimethylcyclohexane, 2,5-dimethylhexane-2,5-dihydroperoxide, di-tert-butyl peroxide, tert-butylcumyl peroxide, 2,5-dimethyl-2,5-bis(tert-butylperoxy)hexane, 2,5-dimethyl-2,5-bis(tert-butylperoxy)-3-hexine, tert-butyl peroxybenzoate, 2,5-dimethyl-2,5-bis(benzoylperoxy)hexane, tert-butyl peroxymaleate or tert-hexylperoxyisopropyl monocarbonate and the like. If desired, a mixture of two or more peroxides can be used.

Without wishing to be bound by any theory, it is believed that the peroxide reagent may undergo a chemical reaction with the polymers of the filled polymer composition and/or the surface-treatment layer of the surface-treated calcium carbonate-containing filler material at the interface of said filler material with the at least one polyethylene polymer and/or the at least one polypropylene polymer, thus leading to the formation of a crosslinked material. Thus, the filled polymer composition may comprise a reaction product of the peroxide reagent, e.g., with the at least one polyethylene polymer and/or the at least one polypropylene polymer and/or the surface-treatment layer of the surface-treated calcium carbonate-containing filler material.

In a preferred embodiment of the present invention, the filled polymer composition does not comprise a peroxide reagent or a reaction product thereof. The present inventors surprisingly found that the use of the inventive surface-treated calcium carbonate-containing filler material, in particular due to the interplay of the surface-treatment layer and the particle size of the ultrafine calcium carbonate-containing filler material, allowed for the improvement of the mechanical properties of the filled polymer composition also in the absence of any peroxide reagent. Thus, it is avoided that the filled polymer composition is transformed into a thermoset or a crosslinked material, which would complicate or even prevent its further recycling.

In an exemplary embodiment of the present invention, the filled polymer composition comprises
a) at least one polyethylene polymer in an amount from 1.0 to 99.5 wt.-%, preferably from 30 to 99 wt.-%, more preferably from 50 wt.-% to 99 wt.-%, still more preferably from 70 to 99 wt.-%, even more preferably from 70 to 98 wt.-%, and most preferably from 70 to 95 wt.-%, based on the total weight of the polymer in the filled polymer composition,
b) at least one polypropylene polymer in an amount from 0.5 to 99 wt.-%, preferably from 1 to 70 wt.-%, more preferably from 1 to 30 wt.-%, even more preferably from 2 to 30 wt.-%, and most preferably from 5 to 30 wt.-%, based on the total weight of the polymer in the filled polymer composition,
c) a surface-treated calcium carbonate-containing filler material in an amount from 5 wt.-% to 70 wt.-%, based on the total weight of the filled polymer composition, comprising, and preferably consisting of, the ultrafine calcium carbonate-containing filler material, having a weight median particle size (d₅₀) value in the range from 0.06 μm to 1.0 μm, preferably from 0.1 to 0.85 μm, more preferably from 0.12 μm to 0.7 μm, most preferably from 0.15 to 0.5 μm, and/or a top cut (d₉₈) value of 8 μm or less, preferably 6 μm or less, more preferably 4 μm or less, and most preferably 2.5 μm or less; and a treatment layer preferably comprising at least one saturated surface-treatment agent being at least one saturated aliphatic linear or branched carboxylic acid and/or a salt thereof, more preferably at least one aliphatic carboxylic acid having a total amount of carbon atoms from C₄ to C₃₀ and/or a salt thereof, still more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound,
d) optionally at least one further polymer in an amount of at most 50 wt.-%, preferably at most 30 wt.-%, more preferably at most 15 wt.-%, and most preferably at most 5 wt.-%, based on the total amount of the polymer in the filled polymer composition, and
e) optionally at least one additive, wherein the total amount of additives is at most 35 wt.-%, preferably at most 5 wt.-%, more preferably at most 2 wt.-%, based on the total weight of the filled polymer composition,
preferably wherein the total amount of polymer being derived from waste polymers is at least 20 wt.-%, more preferably at least 50 wt.-%, even more preferably at least 70 wt.-%, still more preferably at least 85 wt.-%, and most preferably at least 95 wt.-%, based on the total amount of polymer in the filled polymer composition, and
preferably wherein the filled polymer composition does not comprise a peroxide reagent or a reaction product thereof.

In another exemplary embodiment of the present invention, the filled polymer composition comprises
a) at least one polyethylene polymer in an amount from 1.0 to 99.5 wt.-%, preferably from 30 to 99 wt.-%, more preferably from 50 wt.-% to 99 wt.-%, still more preferably from 70 to 99 wt.-%, even more preferably from 70 to 98 wt.-%, and most preferably from 70 to 95 wt.-%, based on the total weight of the polymer in the filled polymer composition,
b) at least one polypropylene polymer in an amount from 0.5 to 99 wt.-%, preferably from 1 to 70 wt.-%, more preferably from 1 to 30 wt.-%, even more preferably from 2 to 30 wt.-%, and most preferably from 5 to 30 wt.-%, based on the total weight of the polymer in the filled polymer composition,
c) a surface-treated calcium carbonate-containing filler material in an amount from 5 wt.-% to 70 wt.-%, based on the total weight of the composition, comprising, and preferably consisting of, the ultrafine calcium carbonate-containing filler material, having a weight median particle size (d₅₀) value in the range from 0.15 to 0.5 μm, and a top cut (d₉₈) value of 8 μm or less, preferably 6 μm or less, more preferably 4 μm or less, and most preferably 2.5 μm or less; and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound,
preferably wherein the total amount of polymer being derived from waste polymers is at least 20 wt.-%, more preferably at least 50 wt.-%, even more preferably at least 70 wt.-%, still more preferably at least 85 wt.-%, and most preferably at least 95 wt.-%, based on the total amount of polymer in the filled polymer composition, and
preferably wherein the filled polymer composition does not comprise a peroxide reagent or a reaction product thereof.

More preferably, the filled polymer composition comprises
a) at least one polyethylene polymer in an amount from 1.0 to 99.5 wt.-%, preferably from 30 to 99 wt.-%, more preferably from 50 wt.-% to 99 wt.-%, still more preferably from 70 to 99 wt.-%, even more preferably from 70 to 98 wt.-%, and most preferably from 70 to 95 wt.-%, based on the total weight of the polymer in the filled polymer composition,
b) at least one polypropylene polymer in an amount from 0.5 to 99 wt.-%, preferably from 1 to 70 wt.-%, more preferably from 1 to 30 wt.-%, even more preferably from 2 to 30 wt.-%, and most preferably from 5 to 30 wt.-%, based on the total weight of the polymer in the filled polymer composition,
c) a surface-treated calcium carbonate-containing filler material in an amount from 5 wt.-% to 70 wt.-%, based on the total weight of the composition, comprising, and preferably consisting of, the ultrafine calcium carbonate-containing filler material, having a weight median particle size (d₅₀) value in the range from 0.15 to 0.5 μm, and a top cut (d₉₈) value of 8 μm or less, preferably 6 μm or less, more preferably 4 μm or less, and most preferably 2.5 μm or less; and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound,
wherein the filled polymer composition does not comprise a peroxide reagent or a reaction product thereof, and
d) optionally at least one further polymer in an amount of at most 30 wt.-%, preferably at most 15 wt.-%, and most preferably at most 5 wt.-%, based on the total amount of the polymer in the filled polymer composition,
preferably wherein the total amount of polymer being derived from waste polymers is at least 50 wt.-%, even more preferably at least 70 wt.-%, still more preferably at least 85 wt.-%, and most preferably at least 95 wt.-%, based on the total amount of polymer in the filled polymer composition.

### The Inventive Process for Producing a Filled Polymer Composition

In a second aspect of the present invention, a process for the production of a filled polymer composition is provided. The process comprises the steps of
a) providing at least one polyethylene polymer and at least one polypropylene polymer and/or a polymer mixture comprising polyethylene and polypropylene,
b) providing a surface-treated calcium carbonate-containing filler material,
wherein the surface-treated calcium carbonate-containing filler material comprises an ultrafine calcium carbonate-containing filler material having
   i) a weight median particle size (d₅₀) value in the range from 0.03 μm to 1.0 μm and
   ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
   wherein the at least one surface-treatment agent
i) has a total amount of carbon atoms from C₄ to C₃₄, and
ii) comprises at least one carboxyl group and/or a derivative thereof,
c) mixing, in any order, the polyethylene polymer and the polypropylene polymer and/or the polymer mixture of step a), and the surface-treated calcium carbonate-containing filler material of step b) to obtain a mixture, and
d) compounding the mixture of step c) to obtain a filled polymer composition, wherein the filled polymer composition comprises the surface-treated calcium carbonate-containing filler material in an amount from 5 wt.-% to 70 wt.-%, based on the total weight of the filled polymer composition.

### Step a)

According to step a) of the inventive process, at least one polyethylene polymer and at least one polypropylene polymer and/or a polymer mixture comprising polyethylene and polypropylene is provided. It is appreciated that the at least one polyethylene polymer and the at least one polypropylene polymer are as defined hereinabove.

It is to be understood that the at least one polyethylene polymer and the at least one polypropylene polymer may be provided separately and/or in the form of a polymer mixture. Preferably, the at least one polyethylene polymer, the at least one polypropylene polymer and/or the polymer mixture are derived from waste polymers.

In a preferred embodiment of the present invention, in step a) a polymer mixture is provided, which is derived from waste polymers comprising polyethylene and polypropylene. The polymer mixture being “derived from” waste polymers is understood in that the polymer mixture is obtained by a purification process. In this embodiment, step a) of providing the polymer mixture may comprise at least one of, preferably at least two of the sub-steps of a1) pre-sorting the waste plastic, a2) grinding the waste plastic, a3) cleaning the waste plastic and a4) sorting the waste plastic, in any order, preferably in the order set out herein.

According to pre-sorting step a1), separate and discrete pieces of different polymeric materials may be identified, e.g., by Fourier-transform infrared spectroscopy (FTIR), near-infrared spectroscopy, optical color recognition, X-ray detection, laser sorting and/or electrostatic detection, and subsequently mechanically separated, e.g., by selective collection and/or automated or manual sorting.

According to grinding step a2), the size of the waste plastic is reduced in order to facilitate the subsequent separation, cleaning and re-processing steps. The grinding step may be performed inter alia by shredding, crushing or milling. Preferably, the average particle size of the ground waste plastic is in the range from 0.2 to 10 mm.

According to cleaning step a3), the waste plastic, which is optionally ground, may be washed with a liquid preferably selected from the group consisting of water, optionally comprising at least one detergent and/or a soap, and/or organic solvents, such as alcohols, ketones and aliphatic hydrocarbons. Preferably, the organic solvent does not dissolve the polymers within the waste plastic.

According to sorting step a4), the polymer mixture preferably undergoes a step selected from gravimetrical sorting and/or sorting by dissolution/reprecipitation.

Preferably, the process for providing the polymer mixture comprises the sub-step of a5) drying the polymer mixture obtained after one of, or more of steps a1) to a4). Drying may take place using any suitable drying equipment known to the skilled person.

It is to be stressed that the separation of polyethylene polymers and polypropylene polymers in such process may be incomplete, such that the polymer mixture indeed is a mixture of polyethylene and polypropylene. Furthermore, the polymer mixture may comprise further polymers, e.g., polyethylene terephthalate (PET), polytrimethylene terephthalate (PTT), polybutylene terephthalate (PBT), polyethylene naphthalate (PEN), but also degradable polyesters, such as polylactic acid (polylactide, PLA) and polyethylene-2,5-furandicarboxylate, polyvinyl chloride, polyvinylidene chloride (PVDC), polyvinylidene fluoride (PVDF) and polytetrafluoroethylene (PTFE), polybutadiene, polyacrylonitrile, polymethylmethacrylate, polyamides, polyurethanes, and mixtures thereof.

Preferably, process steps a1) to a5) are performed such that the polymer mixture comprises the further polymers in an amount of at most 5 wt.-%, preferably at most 2 wt.-%, based on the total amount of polymer in the filled polymer composition.

In a preferred embodiment of the inventive process, in step a) a polymer mixture comprising polyethylene and polypropylene is provided, wherein the polymer mixture is derived from waste polymers.

In another preferred embodiment of the inventive process, in step a) a polymer mixture comprising polyethylene and polypropylene is provided, wherein the polymer mixture is derived from waste polymers, and additionally at least one polyethylene polymer and/or at least one polypropylene polymer is provided, wherein the at least one polyethylene polymer and the at least one polypropylene polymer are derived from virgin polymers.

### Step b)

According to step b) of the inventive process, a surface-treated calcium carbonate-containing filler material is provided. The surface-treated calcium carbonate-containing filler material comprises an ultrafine calcium carbonate-containing filler material having
i) a weight median particle size (d₅₀) value in the range from 0.03 μm to 1.0 μm and
ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
   wherein the at least one surface-treatment agent
i) has a total amount of carbon atoms from C₄ to C₃₄, and
ii) comprises at least one carboxyl group and/or a derivative thereof.

It is appreciated that the surface-treated calcium carbonate-containing filler material, the ultrafine calcium carbonate-containing filler material and the at least one surface-treatment agent and/or salty reaction products thereof are defined hereinabove.

In a preferred embodiment of the present invention, step b) of providing the surface-treated calcium carbonate-containing filler material comprises the sub-steps of
b1) providing the ultrafine calcium carbonate-containing filler material,
b2) providing the at least one surface-treatment agent,
b3) heating the at least one surface-treatment agent of step b2) to a temperature in the range from the melting point of the at least one surface-treatment agent to less than 200° C. to obtain a molten surface-treatment agent,
b4) contacting the ultrafine calcium carbonate-containing filler material of step b1) and the molten surface-treatment agent of step b3) to obtain a surface-treated calcium carbonate-containing filler material,
preferably wherein steps b1) to b4) are performed in absence of a solvent.

It is preferred that in step b1) the ultrafine calcium carbonate-containing filler material is provided in dry form.

It is preferred that steps b3) and b4) are carried out simultaneously, preferably in the same vessel. Step b4) is carried out under mixing. It is appreciated that the mixing can be carried out by any method or in any vessel known to the skilled person resulting in a homogeneous composition. For example, step b4) is carried out in a high speed mixer or pin mill.

Alternatively, the surface-treated calcium carbonate-containing filler material is obtained in a wet surface-treatment step. Suitable wet surface-treatment processes are known to the skilled person, and taught, e.g., in EP3192837 A1.

### Steps c) and d)

According to step c) of the inventive process, the polyethylene polymer and the polypropylene polymer and/or the polymer mixture of step a), and the surface-treated calcium carbonate-containing filler material of step b) are mixed, in any order, to obtain a mixture.

Mixing step c) may be performed by any means known to the skilled person, including, but not limited to, blending, extruding, kneading, and high-speed mixing.

According to step d) of the inventive process, the mixture of step c) is compounded to obtain a filled polymer composition, wherein the filled polymer composition comprises the surface-treated calcium carbonate-containing filler material in an amount from 5 wt.-% to 70 wt.-%, based on the total weight of the filled polymer composition.

In a preferred embodiment of the present invention, mixing step c) and compounding step d) are performed simultaneously. Preferably, the surface-treated calcium carbonate-containing filler material of step b) is admixed after mixing the polyethylene polymer and the polypropylene polymer and/or the polymer mixture of step a), more preferably wherein the mixture of the polyethylene polymer and the polypropylene polymer and/or the polymer mixture of step a) is at least partially in the molten state. Thus, it is appreciated that the mixing step c) may take place during compounding step d).

Mixing step c) and/or compounding step d) may be done with a suitable extruder, preferably by a twin screw extruder (co- or counter-rotating) or by any other suitable continuous compounding equipment, e.g. a continuous co-kneader (Buss), a continuous mixer (Farrel Pomini), a ring extruder (Extricom) or the like. The continuous polymer mass from extrusion may be either pelletized by (hot cut) die face pelletizing with underwater pelletizing, eccentric pelletizing and water ring pelletizing or by (cold cut) strand pelletizing with underwater and conventional strand pelletizing to form the extruded polymer mass into pellets.

Optionally, mixing step c) and/or compounding step d) may also be performed with a discontinuous or batch process using an internal (batch) mixer, e.g. a Banburry mixer (HF Mixing Group) or a Brabender mixer (Brabender) or the like.

During mixing step c) and/or compounding step d), at least one further polymer may be added. The at least one further polymer may be selected from the group comprising polystyrene, polyesters, such as polyethylene terephthalate (PET), polytrimethylene terephthalate (PTT), polybutylene terephthalate (PBT), polyethylene naphthalate (PEN), but also degradable polyesters, such as polylactic acid (polylactide, PLA) and polyethylene-2,5-furandicarboxylate, polyvinyl chloride, polyvinylidene chloride (PVDC), polyvinylidene fluoride (PVDF) and polytetrafluoroethylene (PTFE), polybutadiene, polyacrylonitrile, polymethylmethacrylate, polyamides, polyurethanes, and mixtures thereof. Preferably, the at least one further polymer is selected from the group comprising polystyrene, polyesters, preferably polyethylene terephthalate, polylactic acid, polyhydroxybutyrate and polyethylene-2,5-furandicarboxylate, polyvinyl chloride, polybutadiene, polyacrylonitrile, polymethylmethacrylate, polyamides, polyurethanes, and mixtures thereof. The at least one further polymer may be added in an amount of at most 50 wt.-%, preferably at most 30 wt.-%, more preferably at most 15 wt.-%, and most preferably at most 5 wt.-%, based on the total amount of the polymer in the filled polymer composition.

Additionally or alternatively, during mixing step c) and/or compounding step d), at least one additive may be added. The additive is selected from the group consisting of further fillers, preferably selected from the group consisting of talc, mica, kaolin, bentonite or mixtures thereof, UV-absorbers, light stabilizers, processing stabilizers, antioxidants, heat stabilizers, nucleating agents, metal deactivators, impact modifiers, plasticizers, lubricants, rheology modifiers, processing aids, pigments, dyes, optical brighteners, antimicrobials, antistatic agents, slip agents, anti-block agents, coupling agents, dispersants, compatibilizers, oxygen scavengers, acid scavengers, markers, antifogging agents, surface modifiers, flame retardants, blowing agents, smoke suppressors, or mixtures of the foregoing additives. The at least one additive may be added in an amount of up to 30 wt.-%, preferably up to 5 wt.-%, more preferably up to 2 wt.-%, based on the total weight of the filled polymer composition. The total amount of additives added may be up to 35 wt.-%, preferably up to 5 wt.-%, more preferably up to 2 wt.-%, based on the total weight of the filled polymer composition.

According to one embodiment, a further filler is added. The further filler may be selected from the group comprising carbon black, silica, ground natural calcium carbonate, precipitated calcium carbonate, nanofillers, graphite, clay, talc, diatomaceous earth, barium sulfate, titanium dioxide, wollastonite, and mixtures thereof. Preferably, the further filler is selected from the group consisting of talc, mica, kaolin, bentonite or mixtures thereof. The further filler may added in an amount of at most 30 wt.-%, more preferably at most 15 wt.-%, and most preferably at most 5 wt.-%, based on the total amount of the filled polymer composition.

It is to be understood that the further filler can be distinguished from the surface-treated calcium carbonate-containing filler material, e.g., by its chemical composition and/or by its particle size. Thus, it is to be understood that, if the at least one further filler is selected from ground natural calcium carbonate or precipitated calcium carbonate, said further filler has a weight median particle size (d₅₀) value of more than 1.0 μm and a top cut (d₉₈) value of more than 10 μm and/or does not comprise a surface-treatment layer as defined hereinabove.

In one embodiment, during mixing step c) and/or compounding step d), a peroxide reagent is added. The peroxide reagent can be selected from a very wide range, including peresters, perketals, hydroperoxides, peroxydicarbonates, diacyl peroxides and ketone peroxides. If desired, a mixture of two or more peroxides can be used.

However, in a preferred embodiment of the inventive process, no peroxide reagent is added before, during, or after any one of steps a) to d).

It is appreciated that in compounding step d), a filled polymer composition is obtained. The filled polymer composition comprises the surface-treated calcium carbonate-containing filler material in an amount from 5 wt.-% to 70 wt.-%, based on the total weight of the filled polymer composition. It is to be understood that the amounts of the at least one polyethylene polymer, the at least one polypropylene polymer and/or the polymer mixture comprising polyethylene and polypropylene, the surface-treated calcium carbonate-containing filler material and optionally the at least one further polymer and/or the at least one additive and/or the peroxide reagent, if present, are provided and/or added during mixing step c) and/or compounding step d) such that the so-obtained filled polymer composition comprises the surface-treated calcium carbonate-containing filler material in the required amounts.

If in step a) a polymer mixture comprising polyethylene and polypropylene and being derived from waste polymers is provided, it is appreciated that said polymer mixture may comprise further polymers and further additives. Furthermore, if said polymer mixture is derived from waste polymers comprising the inventive filler, as would be the case, if the inventive filled polymer composition as described hereinabove were to be disposed of and would form part of said waste polymers, the polymer mixture provided in step a) already contains certain amounts of the inventive filler. Consequently, the amounts of polyethylene, polypropylene, further polymers, further additives and the surface-treated calcium carbonate-containing filler material, which may already be present in the polymer mixture have to be taken into account when performing the inventive process.

The skilled person knows how to determine the composition of the polymer mixture by routine methods, such as determination of the ash content, Fourier-transform infrared spectroscopy (FTIR), near-infrared spectroscopy, X-ray detection, laser sorting, nuclear magnetic resonance and/or electrostatic detection methods. If the polymer mixture is derived from post-industrial waste polymers, the composition may be well-known from the manufacturer of said post-industrial waste polymers.

Consequently, the inventive process is performed such that the filled polymer composition obtained in step d) comprises the surface-treated calcium carbonate-containing filler material in an amount from 5 wt.-% to 70 wt.-%, preferably from 5 wt.-% to 60 wt.-%, most preferably from 7 wt.-% to 40 wt.-%, based on the total weight of the filled polymer composition.

Additionally or alternatively, the filled polymer composition obtained in step d) comprises the at least one polypropylene polymer in an amount from 0.5 to 99 wt.-%, preferably from 1 to 70 wt.-%, more preferably from 1 wt.-% to 50 wt.-%, still more preferably from 1 to 30 wt.-%, even more preferably from 2 to 30 wt.-%, and most preferably from 5 to 30 wt.-%, based on the total weight of the polymer in the filled polymer composition. Additionally or alternatively, the filled polymer composition obtained in step d) comprises the at least one polyethylene polymer in an amount from 1.0 to 99.5 wt.-%, preferably from 30 to 99 wt.-%, more preferably from 50 wt.-% to 99 wt.-%, still more preferably from 70 to 99 wt.-%, even more preferably from 70 to 98 wt.-%, and most preferably from 70 to 95 wt.-%, based on the total weight of the polymer in the filled polymer composition.

Additionally or alternatively, the filled polymer composition obtained in step d) comprises a total amount of polymer being derived from waste polymers of at least 20 wt.-%, preferably at least 50 wt.-%, more preferably at least 70 wt.-%, still more preferably at least 85 wt.-%, and most preferably at least 95 wt.-%, based on the total amount of polymer in the filled polymer composition.

Additionally or alternatively, the filled polymer composition obtained in step d) comprises at least one further polymer in an amount of at most 50 wt.-%, preferably at most 30 wt.-%, more preferably at most 15 wt.-%, and most preferably at most 5 wt.-%, based on the total amount of the polymer in the filled polymer composition.

Additionally or alternatively, the filled polymer composition obtained in step d) comprises at least one additive in an amount of up to 30 wt.-%, preferably up to 5 wt.-%, more preferably up to 2 wt.-%, based on the total weight of the filled polymer composition. The total amount of additives may be up to 35 wt.-%, preferably up to 5 wt.-%, more preferably up to 2 wt.-%, based on the total weight of the filled polymer composition.

In a preferred embodiment of the process of the present invention, mixing step c) and compounding step d) are performed simultaneously, wherein the surface-treated calcium carbonate-containing filler material of step b) is admixed after mixing the polyethylene polymer and the polypropylene polymer and/or the polymer mixture of step a), more preferably wherein the mixture of the polyethylene polymer and the polypropylene polymer and/or the polymer mixture of step a) is at least partially in the molten state. For example, the inventive filler may be injected directly into the injection zone of the extruder, e.g., at any split-feed inlet port along the kneading screw of the extruder. A suitable process is disclosed in EP2981568 A1.

In another preferred embodiment of the process of the present invention, compounding step d) is performed at a temperature in the range from 150 to 260° C., more preferably from 170 to 240° C., and most preferably from 180 to 230° C., and/or compounding step d) is an extrusion step.

In a particularly preferred embodiment of the present invention, the mixing step c) comprises the sub-steps of
c1) forming a masterbatch of the surface-treated calcium carbonate-containing filler material provided in step b) and at least one polyethylene polymer or at least one polypropylene polymer provided in step a), wherein the masterbatch comprises the surface-treated calcium carbonate-containing filler material in an amount from 40 to 80 wt.-%, preferably 45 to 75 wt.-%, more preferably 50 to 70 wt.-%, based on the total amount of the masterbatch, and
c2) mixing the masterbatch obtained in step c1) with the same or different at least one polyethylene polymer and/or at least one polypropylene polymer and/or polymer mixture comprising polyethylene and polypropylene of step a) to obtain a mixture comprising polyethylene and polypropylene, preferably wherein mixing step c2) and compounding step d) are performed simultaneously.

It is to be understood that the at least one polyethylene polymer or the at least one polypropylene polymer of step c1) may be the same or different from the at least one polyethylene polymer or the at least one polypropylene polymer provided in step a). However, the at least one polyethylene polymer or the at least one polypropylene polymer of step c1) are as described hereinabove.

Preferably, the masterbatch obtained in step c1) comprises at least one polyethylene polymer or at least one polypropylene polymer being a virgin polymer. In this embodiment, it is preferred that the masterbatch obtained in step c1) is mixed in step c2) with a polymer mixture comprising polyethylene and polypropylene and being derived from waste polymers.

Step c1) may be performed by any compounding method known to the skilled person. Preferably, step c1) is performed by a kneading process, wherein a premix of the surface-treated calcium carbonate-containing filler material of step b) and at least one polyethylene polymer or at least one polypropylene polymer of step a) is continuously fed to an extruder, such as a single screw or twin screw extruder. The extruder is heated to a temperature sufficiently high to allow for efficient mixing of the surface-treated calcium carbonate-containing filler material and the at least one polyethylene polymer or the at least one polypropylene polymer. A suitable temperature range is 150 to 260° C.

Alternatively, the surface-treated calcium carbonate-containing filler material may be added during step c1) to the at least partially molten at least one polyethylene polymer or the at least one polypropylene polymer, e.g., at any split-feed inlet port along the kneading screw of the extruder.

During step c1), at least one further additive as described hereinabove may be added.

The masterbatch may be obtained as a material having a defined shape, such as pellets, spheres, pearls, beads, prills, flakes, chips or slugs, or a non-defined shape, such as, for example, crumbles. Alternatively, the polymer composition may be a mixture of both defined and non-defined shape materials. Preferably, a pelletizing step is performed after the kneading process to provide the masterbatch in the form of pellets.

In a further embodiment of the present invention, the masterbatch obtained in step c1) consists of the surface-treated calcium carbonate-containing filler material of step b) and the polypropylene polymer or the polyethylene polymer of step a).

In another embodiment of the present invention, the process comprises at least one further step e) of forming the filled polymer composition obtained in step d) into an article, preferably by injection moulding or film or sheet formation. Preferred film formation processes include blown film formation and cast film formation.

In an exemplary embodiment of the present invention, the process comprises the steps of
a) providing at least one polyethylene polymer and at least one polypropylene polymer and/or a polymer mixture comprising polyethylene and polypropylene,
b) providing a surface-treated calcium carbonate-containing filler material comprising, and preferably consisting of, the ultrafine calcium carbonate-containing filler material, having a weight median particle size (d₅₀) value in the range from 0.06 μm to 1.0 μm, preferably from 0.1 to 0.85 μm, more preferably from 0.12 μm to 0.7 μm, most preferably from 0.15 to 0.5 μm, and/or a top cut (d₉₈) value of 8 μm or less, preferably 6 μm or less, more preferably 4 μm or less, and most preferably 2.5 μm or less; and a treatment layer preferably comprising at least one saturated surface-treatment agent being at least one saturated aliphatic linear or branched carboxylic acid and/or a salt thereof, more preferably at least one aliphatic carboxylic acid having a total amount of carbon atoms from C₄ to C₃₀ and/or a salt thereof, still more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound,
c) mixing, in any order, the polyethylene polymer and the polypropylene polymer and/or the polymer mixture of step a), and the surface-treated calcium carbonate-containing filler material of step b) to obtain a mixture, and
d) compounding the mixture of step c) to obtain a filled polymer composition, wherein the filled polymer composition comprises the surface-treated calcium carbonate-containing filler material in an amount from 5 wt.-% to 70 wt.-%, based on the total weight of the filled polymer composition, preferably wherein the total amount of polymer being derived from waste polymers is at least 20 wt.-%, more preferably at least 50 wt.-%, even more preferably at least 70 wt.-%, still more preferably at least 85 wt.-%, and most preferably at least 95 wt.-%, based on the total amount of polymer in the filled polymer composition,
wherein preferably no peroxide reagent is added before, during, or after any one of steps a) to d).

In another exemplary embodiment of the present invention, the process comprises the steps of
a) providing at least one polyethylene polymer and at least one polypropylene polymer and/or a polymer mixture comprising polyethylene and polypropylene,
b) providing a surface-treated calcium carbonate-containing filler material comprising, and preferably consisting of, the ultrafine calcium carbonate-containing filler material, having a weight median particle size (d₅₀) value in the range from 0.15 to 0.5 μm, and a top cut (d₉₈) value of 8 μm or less, preferably 6 μm or less, more preferably 4 μm or less, and most preferably 2.5 μm or less; and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound,
c) mixing, in any order, the polyethylene polymer and the polypropylene polymer and/or the polymer mixture of step a), and the surface-treated calcium carbonate-containing filler material of step b) to obtain a mixture, and
d) compounding the mixture of step c) to obtain a filled polymer composition, wherein the filled polymer composition comprises the surface-treated calcium carbonate-containing filler material in an amount from 5 wt.-% to 70 wt.-%, based on the total weight of the filled polymer composition, preferably wherein the total amount of polymer being derived from waste polymers is at least 20 wt.-%, more preferably at least 50 wt.-%, even more preferably at least 70 wt.-%, still more preferably at least 85 wt.-%, and most preferably at least 95 wt.-%, based on the total amount of polymer in the filled polymer composition,
wherein preferably no peroxide reagent is added before, during, or after any one of steps a) to d).

In still another preferred embodiment of the present invention, the process comprises the steps of
a) providing at least one polyethylene polymer and/or at least one polypropylene polymer and a polymer mixture comprising polyethylene and polypropylene,
b) providing a surface-treated calcium carbonate-containing filler material comprising, and preferably consisting of, the ultrafine calcium carbonate-containing filler material, having a weight median particle size (d₅₀) value in the range from 0.06 μm to 1.0 μm, preferably from 0.1 to 0.85 μm, more preferably from 0.12 μm to 0.7 μm, most preferably from 0.15 to 0.5 μm, and/or a top cut (d₉₈) value of 8 μm or less, preferably 6 μm or less, more preferably 4 μm or less, and most preferably 2.5 μm or less; and a treatment layer preferably comprising at least one saturated surface-treatment agent being at least one saturated aliphatic linear or branched carboxylic acid and/or a salt thereof, more preferably at least one aliphatic carboxylic acid having a total amount of carbon atoms from C₄ to C₃₀ and/or a salt thereof, still more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound,
c1) forming a masterbatch of the surface-treated calcium carbonate-containing filler material provided in step b) and at least one polyethylene polymer or at least one polypropylene polymer provided in step a), wherein the masterbatch comprises the surface-treated calcium carbonate-containing filler material in an amount from 40 to 80 wt.-%, preferably 45 to 75 wt.-%, more preferably 50 to 70 wt.-%, based on the total amount of the masterbatch, and
c2) mixing the masterbatch obtained in step c1) with the same or different at least one polyethylene polymer and/or at least one polypropylene polymer and/or polymer mixture comprising polyethylene and polypropylene of step a) to obtain a mixture comprising polyethylene and polypropylene,
d) compounding the mixture of step c2) to obtain a filled polymer composition, wherein the filled polymer composition comprises the surface-treated calcium carbonate-containing filler material in an amount from 5 wt.-% to 70 wt.-%, based on the total weight of the filled polymer composition, preferably wherein mixing step c2) and compounding step d) are performed simultaneously, and preferably wherein the total amount of polymer being derived from waste polymers is at least 20 wt.-%, more preferably at least 50 wt.-%, even more preferably at least 70 wt.-%, still more preferably at least 85 wt.-%, and most preferably at least 95 wt.-%, based on the total amount of polymer in the filled polymer composition,
wherein preferably no peroxide reagent is added before, during, or after any one of steps a) to d).

In yet another preferred embodiment of the present invention, the process comprises the steps of
a) providing a polymer mixture comprising polyethylene and polypropylene being derived from waste polymers and providing at least one polyethylene polymer being a virgin polymer and/or at least one polypropylene polymer being a virgin polymer,
b) providing a surface-treated calcium carbonate-containing filler material comprising, and preferably consisting of, the ultrafine calcium carbonate-containing filler material, having a weight median particle size (d₅₀) value in the range from 0.06 μm to 1.0 μm, preferably from 0.1 to 0.85 μm, more preferably from 0.12 μm to 0.7 μm, most preferably from 0.15 to 0.5 μm, and/or a top cut (d₉₈) value of 8 μm or less, preferably 6 μm or less, more preferably 4 μm or less, and most preferably 2.5 μm or less; and a treatment layer preferably comprising at least one saturated surface-treatment agent being at least one saturated aliphatic linear or branched carboxylic acid and/or a salt thereof, more preferably at least one aliphatic carboxylic acid having a total amount of carbon atoms from C₄ to C₃₀ and/or a salt thereof, still more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound,
c1) forming a masterbatch of the surface-treated calcium carbonate-containing filler material and at least one polyethylene polymer and/or at least one polypropylene polymer provided in step a), wherein the masterbatch comprises the surface-treated calcium carbonate-containing filler material in an amount from 40 to 80 wt.-%, preferably 45 to 75 wt.-%, more preferably 50 to 70 wt.-%, based on the total amount of the masterbatch, and
c2) mixing the masterbatch obtained in step c1) with the same or different at least one polyethylene polymer and/or at least one polypropylene polymer and/or polymer mixture comprising polyethylene and polypropylene of step a) to obtain a mixture comprising polyethylene and polypropylene,
d) compounding the mixture of step c2) to obtain a filled polymer composition, wherein the filled polymer composition comprises the surface-treated calcium carbonate-containing filler material in an amount from 5 wt.-% to 70 wt.-%, based on the total weight of the filled polymer composition, preferably wherein mixing step c2) and compounding step d) are performed simultaneously, and wherein the total amount of polymer being derived from waste polymers is at least 20 wt.-%, more preferably at least 50 wt.-%, even more preferably at least 70 wt.-%, still more preferably at least 85 wt.-%, and most preferably at least 95 wt.-%, based on the total amount of polymer in the filled polymer composition,
wherein no peroxide reagent is added before, during, or after any one of steps a) to d).

### The Inventive Use

According to a third aspect of the present invention, the use of a surface-treated calcium carbonate-containing filler material in a polymer composition comprising at least one polyethylene polymer and at least one polypropylene polymer is provided. The surface-treated calcium carbonate-containing filler material comprises an ultrafine calcium carbonate-containing filler material having
i) a weight median particle size (d₅₀) value in the range from 0.03 μm to 1.0 μm and
ii) a top cut (d₉₈) value of 10 μm or less,
   and a surface-treatment layer on at least a part of the surface of said ultrafine calcium carbonate-containing filler material, wherein the surface-treatment layer comprises at least one surface-treatment agent and/or salty reaction products thereof,
   wherein the at least one surface-treatment agent
i) has a total amount of carbon atoms from C₄ to C₃₄ and
ii) comprises at least one carboxyl group and/or a derivative thereof, for improving the mechanical properties of the polymer composition.

It is appreciated that the surface-treated calcium carbonate-containing filler material, the ultrafine calcium carbonate-containing filler material, the at least one surface-treatment agent and/or salty reaction products thereof, the at least one polyethylene polymer and at least one polypropylene polymer are as defined hereinabove.

In a preferred embodiment of the present invention, the at least one polyethylene polymer and the at least one polypropylene polymer are at least partially derived from waste polymers. Thus, the polymer composition may comprise a mixture of virgin and recycled polymers.

More preferably, the total amount of polymer being derived from waste polymers in the polymer composition is at least 20 wt.-%, more preferably at least 50 wt.-%, even more preferably at least 70 wt.-%, still more preferably at least 85 wt.-%, and most preferably at least 95 wt.-%, based on the total amount of polymer in the polymer composition.

Furthermore, the polymer composition may comprise further polymers, e.g., polyethylene terephthalate (PET), polytrimethylene terephthalate (PTT), polybutylene terephthalate (PBT), polyethylene naphthalate (PEN), but also degradable polyesters, such as polylactic acid (polylactide, PLA) and polyethylene-2,5-furandicarboxylate, polyvinyl chloride, polyvinylidene chloride (PVDC), polyvinylidene fluoride (PVDF) and polytetrafluoroethylene (PTFE), polybutadiene, polyacrylonitrile, polymethylmethacrylate, polyamides, polyurethanes, and mixtures thereof.

In one embodiment of the present invention, the at least one polypropylene polymer is present in the polymer composition in an amount from 0.5 to 99 wt.-%, preferably from 1 to 70 wt.-%, more preferably from 1 wt.-% to 50 wt.-%, most preferably from 1 to 30 wt.-%, based on the total weight of the polymer in the polymer composition. Additionally or alternatively, the at least one polyethylene polymer is present in the inventive polymer composition in an amount from 1.0 to 99.5 wt.-%, preferably from 30 to 99 wt.-%, more preferably from 50 wt.-% to 99 wt.-%, most preferably from 70 to 99 wt.-%, based on the total weight of the polymer in the filled polymer composition. In the case that the at least one polyethylene polymer and the at least one polypropylene polymer are at least partially derived from waste polymers, it is to be understood that the amounts of the at least one polyethylene polymer and the at least one polypropylene polymer are determined at least partially by the source and/or composition of the waste polymer. In view thereof, it is appreciated that the invention is not limited to specific amounts of polyethylene polymer and polypropylene polymer.

As an illustrative example, the polymer composition may comprise a polymer mixture being derived from waste polymers, which comprises, e.g., from 50 to 99 wt.-%, preferably from 70 to 99 wt.-%, more preferably from 70 to 98 wt.-%, and most preferably from 70 to 95 wt.-%, based on the total weight of the polymer mixture, of at least one polyethylene polymer and, e.g., from 1 to 50 wt.-%, preferably from 1 to 30 wt.-%, more preferably from 2 to 30 wt.-%, and most preferably from 5 to 30 wt.-%, based on the total weight of the polymer mixture, of at least one polypropylene polymer. The polymer mixture being derived from waste polymers may be present in an amount of at least 20 wt.-%, preferably at least 50 wt.-%, more preferably at least 70 wt.-%, still more preferably at least 85 wt.-%, and most preferably at least 95 wt.-%, based on the total amount of polymer in the polymer composition. Additionally, the filled polymer composition may comprise at least one further polyethylene polymer being a virgin polymer and/or at least one further polypropylene polymer being a virgin polymer, e.g., such that the polymer mixture and the at least one further polyethylene polymer being a virgin polymer and/or at least one further polypropylene polymer being a virgin polymer add up to 100 wt.-%, based on the total amount of polymer in the polymer composition.

Thus, in a preferred embodiment of the present invention, the polymer composition comprises a total amount of polymer being derived from waste polymers of at least 20 wt.-%, preferably at least 50 wt.-%, more preferably at least 70 wt.-%, still more preferably at least 85 wt.-%, and most preferably at least 95 wt.-%, based on the total amount of polymer in the filled polymer composition.

Preferably, the polymer composition comprises the at least one polyethylene polymer and the at least one polypropylene polymer in a combined amount of at least 50 wt.-%, preferably at least 80 wt.-%, more preferably at least 95 wt.-%, and most preferably at least 98 wt.-%, based on the total weight of the polymer in the polymer composition.

In a particularly preferred embodiment of the present invention, the surface-treated calcium carbonate-containing filler material comprises, and preferably consists of, the ultrafine calcium carbonate-containing filler material and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof.

Preferably, the surface-treated calcium carbonate-containing filler material comprises, and preferably consists of, the ultrafine calcium carbonate-containing filler material and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, wherein the treatment layer does not comprise an unsaturated compound. For example, the surface-treated calcium carbonate-containing filler material consists of the ultrafine calcium carbonate-containing filler material and a treatment layer consisting of at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof.

In an exemplary embodiment of the present invention, the surface-treated calcium carbonate-containing filler material comprises, and preferably consists of, the ultrafine calcium carbonate-containing filler material, having a weight median particle size (d₅₀) value in the range from 0.06 μm to 1.0 μm, preferably from 0.1 to 0.85 μm, more preferably from 0.12 μm to 0.7 μm, most preferably from 0.15 to 0.5 μm, and/or a top cut (d₉₈) value of 8 μm or less, preferably 6 μm or less, more preferably 4 μm or less, and most preferably 2.5 μm or less; and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, optionally wherein the treatment layer does not comprise an unsaturated compound.

For example, the surface-treated calcium carbonate-containing filler material comprises, and preferably consists of, the ultrafine calcium carbonate-containing filler material, having a weight median particle size (d₅₀) value in the range from 0.15 to 0.5 μm, and a top cut (d₉₈) value of 8 μm or less, preferably 6 μm or less, more preferably 4 μm or less, and most preferably 2.5 μm or less; and a treatment layer comprising at least one saturated surface-treatment agent being at least one saturated aliphatic linear or branched carboxylic acid and/or a salt thereof, preferably at least one aliphatic carboxylic acid having a total amount of carbon atoms from C₄ to C₃₀ and/or a salt thereof, more preferably at least one aliphatic carboxylic acid having a total amount of carbon atoms from C₁₂ to C₂₀ and/or a salt thereof, most preferably at least one aliphatic carboxylic acid having a total amount of carbon atoms from C₁₆ to C₁₈ and/or a salt thereof, and/or salty reaction products thereof, preferably wherein the treatment layer does not comprise an unsaturated compound.

In one embodiment of the present invention, the surface-treated calcium carbonate-containing filler material is added to the polymer composition in an amount from 5 wt.-% to 70 wt.-%, preferably from 5 wt.-% to 60 wt.-%, more preferably 7 wt.-% to 40 wt.-%, based on the sum of the weight of the polymer composition and the surface-treated calcium carbonate-containing filler material.

The expression “improving the mechanical properties” is to be understood in that at least one of the mechanical properties of the polymer composition, e.g., impact strength or resilience, tensile modulus or elongation at break, is improved, compared to either the same polymer composition not comprising the surface-treated calcium carbonate-containing filler material or the same polymer composition comprising the same ultrafine calcium carbonate-containing filler material lacking a surface-treatment layer. By “the same polymer composition”, it is meant that a polymer composition not comprising the surface-treated calcium carbonate-containing filler material, or comprising the same ultrafine calcium carbonate-containing filler material lacking a surface-treatment layer, all else being equal, is produced in the same way as the inventive polymer composition, i.e., following the same method steps for its production and using the same remaining compounds in the same relative amounts other than the omitted material (the surface-treated calcium carbonate-containing filler material or the surface-treatment layer, respectively).

Preferably, the tensile modulus of the polymer composition is essentially maintained or increased, preferably by at least 5%, more preferably at least 10%, and most preferably at least 15%, compared to the same polymer composition not comprising the surface-treated calcium carbonate-containing filler material. The tensile modulus is measured according to ISO 527-1:2019.

Preferably, the tensile modulus of the polymer composition is essentially maintained or increased, preferably by at least 5%, more preferably at least 10%, and most preferably at least 15%, compared to the same polymer composition comprising the same ultrafine calcium carbonate-containing filler material lacking a surface-treatment layer. The tensile modulus is measured according to ISO 527-1:2019.

In an embodiment, the tensile modulus of the polymer composition is essentially maintained or increased, preferably by at least 5%, more preferably at least 10%, and most preferably at least 15%, compared to the same polymer composition comprising a calcium carbonate-containing filler material of the prior art.

In a preferred embodiment of the present invention, the impact strength or resilience of the polymer composition is increased, preferably by at least 10%, more preferably by at least 20%, even more preferably by at least 25%, or by at least 50%, for example at least 100%, determined by ISO 179-1eA:2010-11, compared to the same polymer composition not comprising the surface-treated calcium carbonate-containing filler material.

In an embodiment, the impact strength or resilience of the polymer composition is increased, preferably by at least 10%, more preferably by at least 20%, even more preferably by at least 25%, or by at least 50%, for example at least 100%, determined by ISO 179-1eA:2010-11, compared to the same polymer composition comprising a calcium carbonate-containing filler material of the prior art.

In a particularly preferred embodiment of the present invention, the impact strength or resilience of the polymer composition is increased, preferably by at least 10%, more preferably by at least 20%, even more preferably by at least 25%, or by at least 50%, for example at least 100%, determined by ISO 179-1eA:2010-11, compared to the same polymer composition comprising the same ultrafine calcium carbonate-containing filler material lacking a surface-treatment layer.

### The Inventive Article

A fourth aspect of the present invention relates to an article comprising the inventive filled polymer composition as defined hereinabove.

Preferably the inventive article may comprise the inventive filled polymer composition in the form of fibers, filaments, films, threads, sheets, pipes, profiles, molds, injection molded compounds and blow molded compounds.

The inventive article may be used in packaging applications, (in the form of plastic bags, films, containers, bottles, food packagings, microwavable containers, trays etc.), building and construction applications, automotive applications, electrical and electronic applications, agricultural applications, household applications and leisure and sports applications.

The article is preferably selected from the group comprising hygiene products, medical and healthcare products, filter products, geotextile products, agriculture and horticulture products, clothing, footwear and baggage products, household and industrial products, packaging products, construction products and the like. For example, the article may be selected from the group comprising pipes, paint pots, flower pots, garden chairs, bottles, plastic bags, films, containers, food packagings, microwavable containers, trays, automotive parts, bank notes, hinged caps, sweet and snack wrappers, agricultural film, toys, houseware, window frames, profiles, floor and wall covering, cable insulation, garden hoses, garbage bins and the like.

The following examples are meant to additionally illustrate the invention. However, the examples are not meant to restrict the scope of the invention in any way.

### EXAMPLES

### I. Analytical Methods

### BET Specific Surface Area of a Material

Throughout the present document, the specific surface area (in m²/g) of the mineral filler is determined using the BET method (using nitrogen as adsorbing gas), which is well known to the skilled man (ISO 9277:2010). The total surface area (in m²) of the mineral filler is then obtained by multiplication of the specific surface area and the mass (in g) of the mineral filler prior to treatment.

### Amount of Surface-Treatment Layer

The amount of the treatment layer on the calcium carbonate-containing filler material is calculated theoretically from the values of the BET of the untreated calcium carbonate-containing filler material and the amount of at least one hydrophobizing agent that are used for the surface-treatment.

Particle Size Distribution (Mass % Particles with a Diameter <X) and Weight Median Diameter (d₅₀) of a Particulate Material

As used herein and as generally defined in the art, the “d₅₀” value is determined based on measurements made by using a Sedigraph™ 5100 of Micromeritics Instrument Corporation and is defined as the size at which 50% (the median point) of the particle mass is accounted for by particles having a diameter equal to the specified value.

The method and the instrument are known to the skilled person and are commonly used to determine grain size of fillers and pigments. The measurement is carried out in an aqueous solution of 0.1 wt.-% Na₄P₂O₇. The samples are dispersed using a high speed stirrer and supersonics.

### Impact Properties

The impact properties are measured according to ISO 179-1eA:2010-11 on a HIT5.5P device from Zwick Roell. Measurements are performed on notched samples with a hammer of 2 J. All measurements are performed on samples that have been stored under similar conditions after preparation.

### II. Experimental Part

### Part 1: Surface-Treated Calcium Carbonate Preparation

### Materials Used in the Examples:

### 1. Polymer Resin

Example 1: The polymer resins used are a virgin linear low density polyethylene (CAS No. 9002-88-4) LLDPE 6101XR (MFR 20 g/10 min) commercially available from ExxonMobil and a virgin polypropylene (CAS No. 9003-07) PP HF136MO (MFR 20 g/10 min) from Borealis.

Example 2: The polymer resins used are a virgin linear low density polyethylene (CAS No. 9002-88-4) Dowlex® 2631.10UE (MFR 7 g/10 min) commercially available from Resinex® and a virgin polypropylene PP (CAS No. 9003-07) Moplen™ HP525J (MFR 3 g/10 min) from LyondellBasell@.

Example 3: The polymer resins used are a virgin high density polyethylene HDPE (CAS No. 9002-88-4) and a virgin polypropylene PP (CAS No. 9003-07) Moplen HP525J (MFR 3 g/10 min) from LyondellBasell.

Example 4: The polymer resin used is KWR105M2 (MFR 4 g/10 min), a mixture of high density polyethylene HDPE and 15% polypropylene derived from post-consumer waste polymer from KW Plastics.

### 2. Calcium Carbonate-Containing Filler Material CC1

The calcium carbonate CC1 is an untreated dry ground marble from Italy (d₅₀=1.7 μm, d₉₈=8 μm (measured with Sedigraph), BET SSA=4.1 m²/g).

### 3. Calcium Carbonate-Containing Filler Material CC2

The calcium carbonate CC2 is a dry ground marble from Italy (d₅₀=1.7 μm, d₉₈=8 μm (measured with Sedigraph), BET SSA=4.1 m²/g) treated with a fatty acid mixture (about 40 wt.-% stearic acid and about 60 wt.-% palmitic acid).

### 4. Calcium Carbonate-Containing Filler Material CC3

The calcium carbonate CC3 is an untreated wet ground spray dried limestone from France (d₅₀=0.7 μm, d₉₈=2.9 μm (measured with Sedigraph), BET SSA=7.9 m²/g)

### 5. Calcium Carbonate-Containing Filler Material CC4

The calcium carbonate CC4 is a wet ground spray dried limestone from France (d₅₀=0.7 μm, d₉₈=2.9 μm (measured with Sedigraph), BET SSA=7.9 m²/g) treated with a fatty acid mixture (about 40 wt.-% stearic acid and about 60 wt.-% palmitic acid).

### 6. Calcium Carbonate-Containing Filler Material CC5

The calcium carbonate CC5 is a fine marble powder from Norway (d₅₀=0.3 μm, d₉₈=1 μm (measured with Sedigraph), BET SSA=14.4 m²/g) treated with a fatty acid mixture (about 40 wt.-% stearic acid and about 60 wt.-% palmitic acid).

### Part 2: Processing Parameters

### Example 1: Samples Containing 30 wt.-% Filler in a Polymer Matrix of 70 wt.-% LLDPE/30 wt.-% PP

Filled polymer compositions CP-1 to CP-7 were produced on a twin-screw extruder from MARIS (Extruder Type™ 20HT (D=20 mm, L/D=48, D/d=1.55, 11 Nm/cc, 15 kW, die: 2 holes of 3 mm diameter) with the following line settings:
Extruder temperatures: 100° C./230° C./230° C./210° C./170° C./170° C./170° C./170° C./170° C./170° C./180° C./200° C./220° C.
Screw speed: 450 rpm (max speed possible: 1500 rpm)

The polymer matrix used is a mixture of a linear low-density polyethylene (LLDPE) that can be obtained from ExxonMobil under the tradename LLDPE 6101XR and a virgin polypropylene from Borealis under the tradename PP HF136MO. The composition of the polymer matrix is a ratio of 70 wt.-% LLDPE-30 wt.-% PP.

TABLE 1
Preparation and composition of filled polymer compositions CP-1 to CP-7

| Sample | | | Filler material |
|---|---|---|---|
| (comparative/inventive) | Polymer 1 (wt.-%) | Polymer 2 (wt.-%) | (wt.-%) |
| CP-1 (comparative) | LLDPE 6101XR (70%) | PP HF136MO (30%) | / |
| CP-2 (comparative) | / | PP HF136MO (100%) | / |
| CP-3 (comparative) | LLDPE 6101XR (49%) | PP HF136MO (21%) | CC 1 (30%) |
| CP-4 (comparative) | LLDPE 6101XR (49%) | PP HF136MO (21%) | CC 2 (30%) |
| CP-5 (comparative) | LLDPE 6101XR (49%) | PP HF136MO (21%) | CC 3 (30%) |
| CP-6 (inventive) | LLDPE 6101XR (49%) | PP HF136MO (21%) | CC 4 (30%) |
| CP-7 (inventive) | LLDPE 6101XR (49%) | PP HF136MO (21%) | CC 5 (30%) |

### Example 2: Samples Containing 30% Filler Varying the Polymer Matrix Composition

Filled polymer compositions CP-8 to CP-15 were produced on a twin-screw extruder 25:1 from Three Tec (Extruder Type ZE12, die: 0.5 mm) with the following line settings:
Extruder temperatures: 20° C. (feeding)—190° C./210° C./210° C./190° C.
Feeding speed: 12%
Screw speed: 30 rpm
Conveyor speed: 1 rpm
Cut speed: 14 rpm

The polymer matrix used is a mixture of a linear low-density polyethylene (LLDPE) that can be obtained from Resinex under the tradename Dowlex2631.10UE and a virgin polypropylene from LyondellBasell under the tradename Moplen HP525J. The composition of the polymer matrix ratio is varying from 90 wt.-% LLDPE-10 wt.-% PP, to 70 wt.-% LLDPE-30 wt.-% PP, then 30 wt.-% LLDPE-70 wt.-% PP and finally 10 wt.-% LLDPE-90 wt.-% PP.

All polymeric components (granules) were grinded on a Retsch SR300 rotor beater mill prior to use.

TABLE 2
Preparation and composition of filled polymer compositions CP-8 to CP-15

| Sample | | | Filler material |
|---|---|---|---|
| (comparative/inventive) | Polymer 1 (wt.-%) | Polymer 2 (wt.-%) | (wt.-%) |
| CP-8 (comparative) | Dowlex 2631.10UE | Polypropylene Moplen HP | / |
| | (90%) | 525J (10%) | |
| CP-9 (inventive) | Dowlex 2631.10UE | Polypropylene Moplen HP | CC 5 (30%) |
| | (63%) | 525J (7%) | |
| CP-10 (comparative) | Dowlex 2631.10UE | Polypropylene Moplen HP | / |
| | (70%) | 525J (30%) | |
| CP-11 (inventive) | Dowlex 2631.10UE | Polypropylene Moplen HP | CC 5 (30%) |
| | (49%) | 525J (21%) | |
| CP-12 (comparative) | Dowlex 2631.10UE | Polypropylene Moplen HP | / |
| | (30%) | 525J (70%) | |
| CP-13 (inventive) | Dowlex 2631.10UE | Polypropylene Moplen HP | CC 5 (30%) |
| | (21%) | 525J (49%) | |
| CP-14 (comparative) | Dowlex 2631.10UE | Polypropylene Moplen HP | / |
| | (10%) | 525J (90%) | |
| CP-15 (inventive) | Dowlex 2631.10UE | Polypropylene Moplen HP | CC 5 (30%) |
| | (7%) | 525J (63%) | |

### Example 3: Samples Containing 30 wt.-% Filler in a Polymer Matrix of 70 wt.-% HDPE/30 wt.-% PP

Filled polymer compositions CP-16 to CP-22 were produced on a twin-screw extruder 25:1 from Three Tec (Extruder Type ZE12, die: 0.5 mm) with the following line settings:
Extruder temperatures: 20° C. (feeding)—210° C./230° C./230° C./210° C.
Feeding speed: 15%
Screw speed: 50 rpm
Conveyor speed: 1.5 rpm
Cut speed: 25 rpm

Besides the conveyor belt a water bath is used to cool down the strand before cutting it.

The polymer matrix used is a mixture of a high-density polyethylene (HDPE) and a virgin polypropylene from LyondellBasell under the tradename Moplen HP525J. The composition of the polymer matrix ratio is 70 wt.-% HDPE-30 wt.-% PP.

All polymeric components (granules) were grinded on a Retsch SR300 rotor beater mill prior to use.

TABLE 3
Preparation and composition of filled polymer compositions CP-16 to CP-22

| Sample | Polymer 1 | | Filler material |
|---|---|---|---|
| (comparative/inventive) | (wt.-%) | Polymer 2 (wt.-%) | (wt.-%) |
| CP-16 (comparative) | HDPE (100%) | | |
| CP-17 (comparative) | HDPE (70%) | PP HF136MO (30%) | / |
| CP-18 (comparative) | / | PP HF136MO (100%) | / |
| CP-19 (comparative) | HDPE (49%) | PP HF136MO (21%) | CC 1 (30%) |
| CP-20 (comparative) | HDPE (49%) | PP HF136MO (21%) | CC 2 (30%) |
| CP-21 (inventive) | HDPE (49%) | PP HF136MO (21%) | CC 4 (30%) |
| CP-22 (inventive) | HDPE (49%) | PP HF136MO (21%) | CC 5 (30%) |

### Example 4: Samples Containing 20 wt.-% Filler in a Polymer Derived from Post-Consumer Waste Polymer

Filled polymer compositions CP-23 to CP-27 were produced on a twin-screw extruder from MARIS (Extruder Type™ 20HT (D=20 mm, L/D=48, D/d=1.55, 11 Nm/cc, 15 kW, die: 2 holes of 3 mm diameter) with the following line settings
Extruder temperatures: 70° C./190° C./190° C./180° C./170° C./170° C./170° C./170° C./170° C./170° C./180° C./190° C./210° C.
Screw speed: 400 rpm (max speed possible: 1500 rpm)
   The polymer matrix used is a mixture of high-density polyethylene (HDPE) and 15% polypropylene (PP) that can be obtained from KW Plastics under the tradename KWR105M2

TABLE 4
Preparation and composition of filled
polymer compositions CP-23 to CP-27

| Sample | | Filler material |
|---|---|---|
| (comparative/inventive) | Polymer (wt.-%) | (wt.-%) |
| CP-23 (comparative) | KWR105M2 (100%) | / |
| CP-24 (comparative) | KWR105M2 (80%) | CC 1 (20%) |
| CP-25 (comparative) | KWR105M2 (80%) | CC 2 (20%) |
| CP-26 (inventive) | KWR105M2 (80%) | CC 4 (20%) |
| CP-27 (inventive) | KWR105M2 (80%) | CC 5 (20%) |

### Part 3: Effect on Impact Properties

Charpy samples were made by using a Xplore IM12 injection moulder from Xplore Instruments B.V with pellets produced as described in Tables 1, 2, 3 and 4 with the settings indicated in Table 5:

TABLE 5
Xplore IM12 conditions

| | | | |
|---|---|---|---|
| Melt temperature | 210° | C. | |
| Mould temperature | 45° | C. | |
| Melting time | 3 | min | |
| Pressure 1 + time | 7 | bars | 2 s |
| Pressure 2 + time | 7 to 8 | bars | 3 s |
| Pressure 3 + time | 8 | bars | 12 s |

The dimension of the produced samples are the following ones: 80 mm×10 mm×4 mm. These samples have been notched by using an Automatic NotchVis Plus from CEAST. The radius of the notch is 0.25 mm with a depth of 2 mm. Impact tests are made according to ISO179-1eA (notched).

TABLE 6.1
Effect of the particle size of the ultrafine calcium carbonate-containing filler material on
impact properties of the filled polymer compositions according to ISO179-1eA.

| | CP-1 | CP-2 | CP-3 | CP-4 | CP-5 | CP-6 | CP-7 |
|---|---|---|---|---|---|---|---|
| | (comp) | (comp) | (comp) | (comp) | (comp) | (inv) | (inv) |
| Resilience (kJ/m²) | 7.0 | 2.6 | 2.5 | 4.9 | 2.1 | 7.6 | 11.9 |

As can be seen from table 6.1, with untreated filler a reduction of the particle size does not allow for an improvement of the impact strength. But, it can be observed that once the filler is treated, decreasing the particle size of the filler improves the impact strength of the filled polymer composition significantly.

TABLE 6.2
Impact properties according to ISO179-1eA of different
filled polymer compositions containing 30 wt.-% filler.

| | CP-8 | CP-9 | CP-10 | CP-11 |
|---|---|---|---|---|
| | (comp) | (inv) | (comp) | (inv) |
| Resilience (kJ/m²) | 14.2 | 20.2 | 6.8 | 19.7 |

| | CP-12 | CP-13 | CP-14 | CP-15 |
|---|---|---|---|---|
| | (comp) | (inv) | (comp) | (inv) |
| Resilience (kJ/m²) | 3.9 | 6.5 | 3.3 | 6 |

As can be seen from table 6.2, this example confirms that the impact strength/resilience can be improved by using a surface-treated ultrafine calcium carbonate-comprising filler material, when compared to a similar unfilled composition regardless of the composition of the polymer mixture.

TABLE 6.3
Effect of the particle size of the ultrafine calcium carbonate-containing filler material on
impact properties of polymer compositions according to ISO179-1eA.

| | CP-16 | CP-17 | CP-18 | CP-19 | CP-20 | CP21 | CP-22 |
|---|---|---|---|---|---|---|---|
| | (comp) | (comp) | (comp) | (comp) | (comp) | (inv) | (inv) |
| Resilience (kJ/m²) | 22.8 | 10.6 | 4.9 | 5.9 | 9.0 | 27.3 | 23.4 |

As can be seen from table 6.3, when the filler is surface-treated, decreasing the particle size of the filler improves the impact strength of the polymer composition.

TABLE 6.4
Effect of the particle size of the ultrafine calcium
carbonate-containing filler material on impact properties
of polymer compositions according to ISO179-1eA.

| | CP-23 | CP-24 | CP-25 | CP-26 | CP-27 |
|---|---|---|---|---|---|
| | (comp) | (comp) | (comp) | (inv) | (inv) |
| Resilience (kJ/m²) | 8.4 | 3.4 | 8.1 | 15.8 | 11.3 |

As can be seen from table 6.4, when the filler is surface-treated, using a surface-treated ultrafine calcium carbonate improves the impact strength of the polymer composition derived from waste polymers.

1.-17. (canceled)

18. A filled polymer composition comprising
a) at least one polyethylene polymer,
b) at least one polypropylene polymer, and
c) a surface-treated calcium carbonate-containing filler material in an amount from 5 wt.-% to 70 wt.-%, based on the total weight of the composition,
wherein the surface-treated calcium carbonate-containing filler material comprises
an ultrafine calcium carbonate-containing filler material having
i) a weight median particle size (d₅₀) value in the range from 0.03 μm to 1.0 μm and
ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
wherein the at least one surface-treatment agent
i) has a total amount of carbon atoms from C₄ to C₃₄, and
ii) comprises at least one carboxyl group and/or a derivative thereof.

19. The filled polymer composition of claim 1, wherein the ultrafine calcium carbonate-containing filler material has
i) a weight median particle size (d₅₀) value in the range from 0.06 μm to 1.0 μm, and/or
ii) a top cut (d₉₈) value of 8 μm or less, and/or
iii) a specific surface area (BET) from 0.5 to 120 m²/g, as measured by the BET method, and/or
iv) a residual total moisture content of at most 0.5 wt.-%, based on the total dry weight of the ultrafine calcium carbonate-containing filler material.

20. The filled polymer composition of claim 1, wherein the ultrafine calcium carbonate-containing filler material has
i) a weight median particle size (d₅₀) value in the range from 0.15 to 0.5 μm, and/or
ii) a top cut (d₉₈) value of 2.5 μm or less, and/or
iii) a specific surface area (BET) from 8 to 20 m²/g, as measured by the BET method, and/or
iv) a residual total moisture content of at most 0.3 wt.-%, based on the total dry weight of the ultrafine calcium carbonate-containing filler material.

21. The filled polymer composition of claim 1, wherein the surface-treatment layer is present on the ultrafine calcium carbonate-containing filler material in an amount of from 0.1 to 10 wt.-%, based on the total amount of the surface-treated calcium carbonate-containing filler material.

22. The filled polymer composition of claim 1, wherein the surface-treatment layer is present on the ultrafine calcium carbonate-containing filler material in an amount of from 2 to 4 wt.-%, based on the total amount of the surface-treated calcium carbonate-containing filler material.

23. The filled polymer composition of claim 1, wherein the surface-treatment layer does not comprise an unsaturated compound.

24. The filled polymer composition of claim 1, wherein the surface-treated calcium carbonate-containing filler material has
i) a hydrophilicity in the range from 0.01 to 4, indicated as the volumetric ratio of water:ethanol, measured at +23° C. (±2° C.) with the sedimentation method, and/or
ii) a moisture pick up susceptibility from 0.01 to 5 mg/g.

25. The filled polymer composition of claim 1, wherein the surface-treated calcium carbonate-containing filler material has
i) a hydrophilicity in the range from 0.04 to 1, indicated as the volumetric ratio of water:ethanol, measured at +23° C. (±2° C.) with the sedimentation method, and/or
ii) a moisture pick up susceptibility from 0.03 to 1.2 mg/g.

26. The filled polymer composition of claim 1, wherein the at least one surface-treatment agent is a saturated surface-treatment agent.

27. The filled polymer composition of claim 1, wherein the at least one surface-treatment agent is a saturated surface-treatment agent selected from the group consisting of
I) at least one saturated aliphatic linear or branched carboxylic acid and/or a salt thereof,
II) at least one mono-substituted succinic anhydride consisting of succinic anhydride mono-substituted with a group selected from a linear, branched, and cyclic aliphatic group having a total amount of carbon atoms from C₂ to C₃₀ in the substituent and/or a salt or an acid thereof,
III) salty reaction products of the materials according to I) and II), and
IV) mixtures of the materials according to I) to III).

28. The filled polymer composition of claim 1, wherein the at least one surface-treatment agent is an unsaturated surface-treatment agent selected from the group consisting of
I) at least one mono-substituted succinic anhydride consisting of succinic anhydride mono-substituted with a group selected from a linear, branched and cyclic unsaturated group having a total amount of carbon atoms from C₂ to C₃₀ in the substituent and/or a salt or an acid thereof, and
II) salty reaction products of the materials according to I).

29. The filled polymer composition of claim 1, wherein
a) the at least one polypropylene polymer is present in an amount from 0.5 to 99 wt.-%, based on the total weight of the polymer in the filled polymer composition, and/or
b) the surface-treated calcium carbonate-containing filler material is present in an amount from 5 wt.-% to 70 wt.-%, based on the total weight of the filled polymer composition.

30. The filled polymer composition of claim 1, wherein
a) the at least one polypropylene polymer is present in an amount from 1 to 30 wt.-%, based on the total weight of the polymer in the filled polymer composition, and/or
b) the surface-treated calcium carbonate-containing filler material is present in an amount from 7 wt.-% to 40 wt.-%, based on the total weight of the filled polymer composition.

31. The filled polymer composition of claim 1, which does not comprise a peroxide reagent and/or a reaction product thereof.

32. The filled polymer composition of claim 1, further comprising at least one additive selected from the group consisting of a further filler, talc, mica, kaolin, bentonite, UV-absorbers, light stabilizers, processing stabilizers, antioxidants, heat stabilizers, nucleating agents, metal deactivators, impact modifiers, plasticizers, lubricants, rheology modifiers, processing aids, pigments, dyes, optical brighteners, antimicrobials, antistatic agents, slip agents, anti-block agents, coupling agents, dispersants, compatibilizers, oxygen scavengers, acid scavengers, markers, antifogging agents, surface modifiers, flame retardants, blowing agents, smoke suppressors, and mixtures thereof, and/or
further comprising at least one of a further polymer, polystyrene, polyesters, polyethylene terephthalate, polylactic acid, polyhydroxybutyrate, polyethylene-2,5-furandicarboxylate, polyvinyl chloride, polybutadiene, polyacrylonitrile, polymethylmethacrylate, polyamides, polyurethanes, and mixtures thereof.

33. The filled polymer composition of claim 1, wherein the impact strength of the filled polymer composition is increased by at least 5%, determined by ISO 179-1eA:2010-11, compared to the same polymer composition not comprising the surface-treated calcium carbonate-containing filler material or compared to the same polymer composition comprising the same ultrafine calcium carbonate-containing filler material lacking a surface-treatment layer.

34. The filled polymer composition of claim 1, wherein the tensile modulus of the filled polymer composition is increased by at least 5%, determined by ISO 527-1:2019, compared to the same polymer composition not comprising the surface-treated calcium carbonate-containing filler material or compared to the same polymer composition comprising the same ultrafine calcium carbonate-containing filler material lacking a surface-treatment layer.

35. An article comprising the filled polymer composition of claim 1.

36. A process for the production of a filled polymer composition, comprising the steps of
a) providing at least one polyethylene polymer and at least one polypropylene polymer and/or a polymer mixture comprising polyethylene and polypropylene,
b) providing a surface-treated calcium carbonate-containing filler material,
wherein the surface-treated calcium carbonate-containing filler material comprises an ultrafine calcium carbonate-containing filler material having
i) a weight median particle size (d₅₀) value in the range from 0.03 μm to 1.0 μm and
ii) a top cut (d₉₈) value of 10 μm or less, and
a surface-treatment layer on at least a part of the surface of said ultrafine calcium carbonate-containing filler material, wherein the surface-treatment layer comprises at least one surface-treatment agent and/or salty reaction products thereof,
wherein the at least one surface-treatment agent
i) has a total amount of carbon atoms from C₄ to C₃₄, and
ii) comprises at least one carboxyl group and/or a derivative thereof,
c) mixing, in any order, the polyethylene polymer and the polypropylene polymer and/or the polymer mixture of step a), and the surface-treated calcium carbonate-containing filler material of step b) to obtain a mixture, and
d) compounding the mixture of step c) to obtain a filled polymer composition, wherein the filled polymer composition comprises the surface-treated calcium carbonate-containing filler material in an amount from 5 wt.-% to 70 wt.-%, based on the total weight of the filled polymer composition.

37. The process of claim 36, wherein
i) mixing step c) and compounding step d) are performed simultaneously and/or
ii) compounding step d) is performed at a temperature in the range from 150 to 260° C., and/or
iii) compounding step d) is an extrusion step.

38. The process of claim 36, wherein
i) mixing step c) and compounding step d) are performed simultaneously, wherein the surface-treated calcium carbonate-containing filler material of step b) is admixed after mixing the polyethylene polymer and the polypropylene polymer and/or the polymer mixture of step a), and wherein the mixture of the polyethylene polymer and the polypropylene polymer and/or the polymer mixture of step a) is at least partially in the molten state and/or
ii) compounding step d) is performed at a temperature in the range from 180 to 230° C., and/or
iii) compounding step d) is an extrusion step.

39. The process of claim 36, wherein mixing step c) comprises the sub-steps of
c1) forming a masterbatch of the surface-treated calcium carbonate-containing filler material provided in step b) and at least one polyethylene polymer or at least one polypropylene polymer provided in step a), wherein the masterbatch comprises the surface-treated calcium carbonate-containing filler material in an amount from 40 to 80 wt.-%, based on the total amount of the masterbatch, and
c2) mixing the masterbatch obtained in step c1) with the same or different at least one polyethylene polymer and/or at least one polypropylene polymer and/or polymer mixture comprising polyethylene and polypropylene of step a) to obtain a mixture comprising polyethylene and polypropylene.

40. The process of claim 36, wherein mixing step c) comprises the sub-steps of
c1) forming a masterbatch of the surface-treated calcium carbonate-containing filler material provided in step b) and at least one polyethylene polymer or at least one polypropylene polymer provided in step a), wherein the masterbatch comprises the surface-treated calcium carbonate-containing filler material in an amount from 50 to 70 wt.-%, based on the total amount of the masterbatch, and
c2) mixing the masterbatch obtained in step c1) with the same or different at least one polyethylene polymer and/or at least one polypropylene polymer and/or polymer mixture comprising polyethylene and polypropylene of step a) to obtain a mixture comprising polyethylene and polypropylene, wherein mixing step c2) and compounding step d) are performed simultaneously.

41. The process of claim 36, further comprising the step of
e) forming the filled polymer composition obtained in step d) into an article.

42. The process of claim 36, further comprising the step of
e) forming the filled polymer composition obtained in step d) into an article, by injection moulding or film or sheet formation.
